(19) United States
(12) Patent Application Publication
(10) Pub. No.: US 2018/0137629 A1
(43) Pub. Date: May 17, 2018

(54) PROCESSING APPARATUS, IMAGING APPARATUS AND AUTOMATIC CONTROL SYSTEM

(71) Applicant: KABUSHIKI KAISHA TOSHIBA, Tokyo (JP)

(72) Inventors: Nao MISHMA, Tokyo (JP); Yasuke Moriuchi, Tokyo (JP); Takeshi Mita, Yokohama (JP)

(73) Assignee: KABUSHIKI KAISHA TOSHIBA, Tokyo (JP)

(21) Appl. No.: 15/701,340

(22) Filed: Sep. 11, 2017

(30) Foreign Application Priority Data
Nov. 11, 2016 (JP) 2016-220642
Jul. 18, 2017 (JP) 2017-139402

(51) Int. Cl. G06T 7/246; G06T 5/50; G06T 5/00; G06T 7/174

(52) U.S. Cl. CPC G06T 7/248; G06T 7/174; G06T 5/003; G06T 5/50

(57) ABSTRACT

According to one embodiment, a processing apparatus includes a memory and a processor. The processor is electrically coupled to the memory and is configured to acquire a first image of an object and a second linage of the object, the first image including blur having a shape indicated by a symmetric first blur function, the second image including blur having a shape indicated by an asymmetric second blur function, calculate a distance to the object, based on correlation between the first blur function and the second blur function, and calculate reliability of the distance, based on a degree of the correlation.

### CROSS-REFERENCE TO RELATED APPLICATIONS

This application is based upon and claims the benefit of priority from Japanese Patent Applications No. 2016-220642, filed Nov. 11, 2016; and No. 2017-139402, filed Jul. 18, 2017, the entire contests of all of which are incorporated herein by reference.

### FIELD

Embodiments described herein relate generally to a processing apparatus, an imaging apparatus, and an automatic control system.

### BACKGROUND

Recently, an image processing technology of obtaining a distance to an object from an image has been noticed.

### BRIEF DESCRIPTION OF THE DRAWINGS

FIG. 1 is a block diagram showing an example of a hardware configuration of an imaging apparatus according to embodiments.

FIG. 2 is an illustration showing a configuration example of a filter according to the embodiments.

FIG. 3 is a graph showing an example of transmittance characteristics of a filter area according to the embodiments.

FIG. 4 is an illustration for explanation of variation of a ray of light by a color-filtered aperture and a shape of a blur according to the embodiments.

FIG. 5 is a block diagram showing a functional configuration example of the imaging apparatus according to embodiments.

FIG. 6 is an illustration showing an example of a blur function of a reference image according to the embodiments.

FIG. 7 is an illustration showing an example of a blur function of a target linage according to the embodiments.

FIG. 8 is an illustration showing an example of a convolution kernel according to the embodiments.

FIG. 9 is a first illustration for explanation of reliability calculation in the embodiments.

FIG. 10 is a second illustration for explanation of the reliability calculation in the embodiments.

FIG. 11 is a third illustration for explanation of the reliability calculation in the embodiments.

FIG. 12 is a fourth illustration for explanation of the reliability calculation in the embodiments.

FIG. 13 is a graph for explanation of a distance and a correlated value at stereo matching.

FIG. 14 is a graph showing an example of a method of calculating a curvature of a correlation function in the embodiments.

FIG. 15 is an illustration showing an example of an output format of a distance and reliability of the distance in the embodiments.

FIG. 16 is an illustration showing another example of an output format of a distance and reliability of the distance in the embodiments.

FIG. 17 is a flowchart showing an example of a flow of image processing in the embodiments.

FIG. 18 is a block diagram showing a functional configuration example of a robot according to embodiments.

FIG. 19 is an illustration showing an operation example of the robot according to the embodiments, based on the reliability of the distance.

FIG. 20 is a block diagram showing a functional configuration example of a mobile object according to embodiments.

FIG. 21 is an illustration showing an operation example of the mobile object according to the embodiments, based on the reliability of the distance.

FIG. 22 is a second illustration showing an operation example of the mobile object according to the embodiments, based on the reliability of the distance.

FIG. 23 is a block diagram showing a functional configuration example of a monitoring system according to embodiments.

FIG. 24 is an illustration for explanation of a processing example in the monitoring system according to the embodiments, based on the reliability of the distance.

FIG. 25 is an illustration for explanation of a processing example in the monitoring system according to the embodiments, based on the distance.

FIG. 26 is an illustration showing a distance presentation example in the monitoring system according to the embodiments.

FIG. 27 is an illustration shoving a message display example in the monitoring system according to the embodiments.

FIG. 28 shows an installation example of the imaging apparatus according to the second embodiment.

FIGS. 29A and 29B show an example of rotation of the imaging apparatus according to the second embodiment.

FIG. 30 is an exemplary block diagram showing an electric structure of the system according to the second embodiment.

FIG. 31 is an exemplary functional block diagram for the distance calculation and display control according to the second embodiment.

FIG. 32 shows an example of inclination correction of an object captured by the imaging apparatus according to the second embodiment

FIGS. 33A and 33B show an example of the color filter of the imaging apparatus according to the second embodiment.

FIGS. 34A and 34B show a first modified example of the color filter of the imaging apparatus according to the second embodiment.

FIGS. 35A and 35B show a second modified example of the color filter of the imaging apparatus according to the second embodiment.

FIG. 36 shows a third modified example of the color filter of the imaging apparatus according to the second embodiment.

FIGS. 37A and 37B show a fourth modified example of the color filter of the imaging apparatus according to the second embodiment.

FIG. 38 shows an example of installation of an imaging apparatus according to the third embodiment.

FIGS. 39A and 39B show an example of rotation of the imaging apparatus according to the third embodiment.

FIGS. 40A and 40B show examples of the first main axis and second main axis according to the third embodiment.

FIG. 41 is an exemplary block diagram showing a monitoring system according to the first application example of the embodiments.

FIG. 42 shows a use example of the monitoring system.

FIG. 43 is an exemplary block diagram showing an automatic door system according to the second application example of the embodiments.

FIGS. 44A and 44B show an example of operation of the automatic door system.

FIG. 45 is an exemplary block diagram showing an automatic vehicle door system according to a variation example of the automatic door system.

FIG. 46 is an exemplary block diagram showing a moving object control system according to the third application example of the embodiments.

FIG. 47 shows a robot as an example of the moving object according to the third application example.

FIG. 48 is an exemplary functional block diagram for a drone as an example of the moving object according to the third application example.

FIG. 49 is an exemplary functional block diagram for a vehicle as an example of the moving object according to the third application example.

### DETAILED DESCRIPTION

In general, according to one embodiment, a processing apparatus includes a memory and a processor. The processor is electrically coupled to the memory and is configured to: acquire a first image of an object and a second image of the object, the first image including blur having a shape indicated by a symmetric first blur function, the second image including blur having a shape indicated by an asymmetric second blur function; calculate a distance to the object, based on correlation between the first blur function and the second blur function; and calculate reliability of the distance, based on a degree of the correlation.

Embodiments will be described hereinafter with reference to the accompanying drawings.

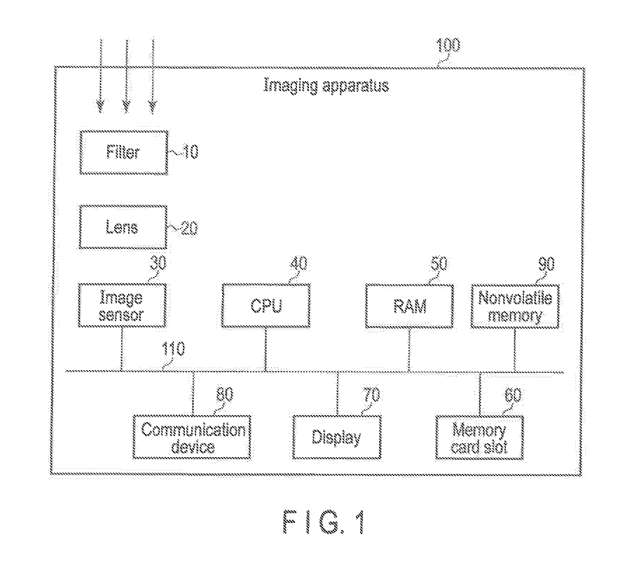

FIG. 1 is a block diagram showing an example of a hardware configuration of an imaging apparatus according to embodiments. The imaging apparatus 100 comprises a function of capturing an image and processing the captured image. The imaging apparatus 100 may be realized, for example, as a camera, a portable telephone or smartphone with a camera function, a portable information terminal such as a personal digital assistant/personal data assistant (PDA), a personal computer with a camera function, an embedded system incorporated in various electronic devices, etc.

As shown in FIG. 1, the imaging apparatus 100 comprises, for example, a filter 10, a lens 20, an image sensor 30, an image processor, and a storage. The image processor is composed of, for example, a circuit such as a CPU 40. The storage is composed of, for example, a RAM 50 and a nonvolatile memory 90. The imaging apparatus 100 may further comprise a memory card slot 60, a display 70, and a communication device 80. For example, the image sensor 30, the CPU 40, the RAM 50, the memory card slot 60, the display 70, the communication device 80, and the nonvolatile memory 90 may be mutually connected via a bus 110.

The image sensor 30 generates an image by receiving light transmitted through the filter 10 and the lens 20 and converting (photoelectric converting) the received light into an electric signal. As the image sensor 30, for example, a charge coupled device (CCD) or a complementary metal oxide semiconductor (CMOS) is used. The image sensor 30 includes, for example, an imaging element (first sensor 31) which receives red (R) light, an imaging element (second sensor 32) which receives green (G) light, and an imaging element (third sensor 33) which receives blue (B) light. Each of the imaging sensors receives light of a corresponding wavelength band and converts the received light into an electric signal. A color image can be generated by A/D conversion of this electric signal. An R image, a G image, and a B image can be generated by using the electric signals for the respective red, green, and blue imaging elements. That is, the color image, the R image, the G image, and the B image can be generated simultaneously. In other words, the imaging apparatus 100 can obtain the color image, the R image, the G image, and the B image at one imaging.

The CPU 40 is a processor which controls operations of various components in the imaging apparatus 100. The CPU 40 executes various programs loaded from the nonvolatile memory 90 serving as a storage device to the RAM 50. The image generated by the image sensor 30 and a result of processing of the image can also be stored in the nonvolatile memory 90.

Various types of portable storage media such as an SD memory card and an SDHC memory card can be inserted into the memory card slot 60. If the storage medium is inserted into the memory card slot 60, the data can be written to or read from the storage medium. The data is, for example, image data and distance data.

The display 70 is, for example, liquid crystals display (LCD). The display 70 displays a screen image based on the display signal generated by the CPU 40 or the like. The display 70 may be a touchscreen display. In this case, for example, a touch panel may be arranged on an upper surface of the LCD. The touch panel is a capacitive pointing device for execution of inputting on the screen of the LCD. A contact position on the screen which is touched by a finger, movement of the contact position, and the like are detected by the touch panel.

The communication device 80 is an interface instrument configured to execute wired or wireless communications. The communication device 80 includes a transmitter which executes wired or wireless signal transmission and a receiver which executes wired or wireless signal reception.

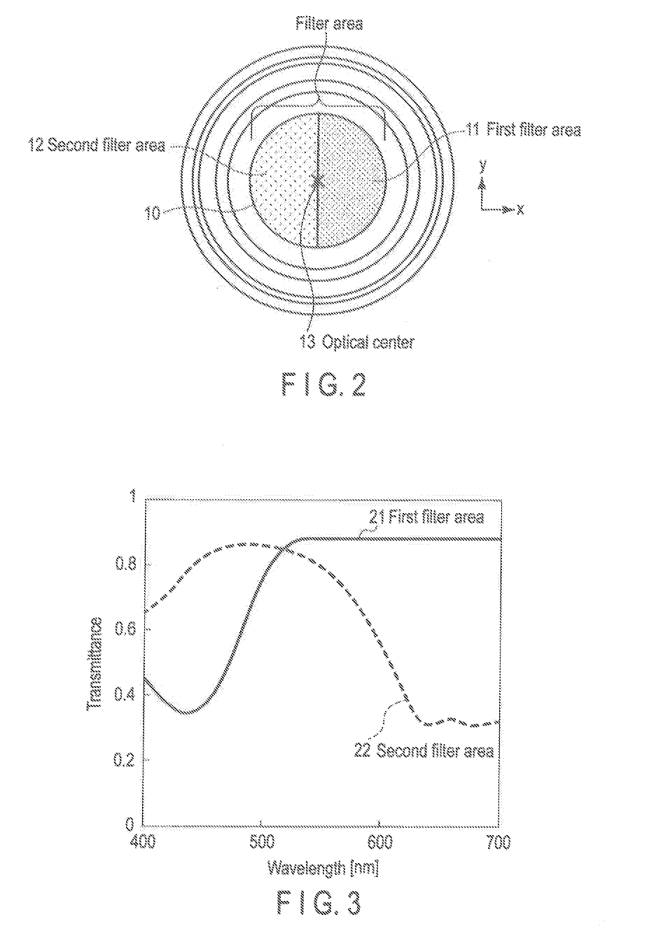

FIG. 2 is an illustration showing a configuration example of the filter 10. The filter 10 is composed off for example, color filter areas of two colors, i.e., a first filter area 11 and a second filter area 12. The center of the filter 10 matches an optical center 13 of the imaging apparatus 100. The first filter area 11 and the second filter area 12 are shaped to have a non-point symmetry about the optical center 13, respectively. In addition, for example, the filter areas 11 and 12 do not overlap each other, and the entire filter area is composed of two filter areas 11 and 12. In the example illustrated in FIG. 2, the first filter area 11 and the second filter area 12 have a semicircular shape obtained by dividing the circular filter 10 by a line segment passing through the optical center 13. Moreover, the first filter area 11 is, for example, a yellow (Y) filter area, and the second filter area 12 is, for example, a cyan (C) filter area.

The filter 10 has two or more color filter areas. Each of the color filter areas has an asymmetric shape about the optical center of the imaging apparatus. A part of a wavelength range of the light transmitted through one of the color filter areas, for example, overlaps a part of a wavelength range of the light transmitted through the other one of the color filter areas. The wavelength range of the light transmitted through one of the color filter areas, for example, may include the wavelength range of the light transmitted through the other one of the color filter areas. The filter 10 of FIG. 2 will be hereinafter explained as an example.

By arranging the filter 10 at an aperture portion of a camera, a color-filtered aperture which is the structural aperture where the aperture portion is divided in two colors is constituted. The image sensor 30 generates an image, based a light beam transmitted through the color-filtered aperture. The lens 20 may be arranged between the filter 10 and the image sensor 30, on an optical path of the light incident on the image sensor 30. The filter 10 may be arranged between the lens 20 and the image sensor 30, on an optical path of the light incident on the image sensor 30. If a plurality of lenses 20 are provided, the filter 10 may be arranged between two lenses 20.

More specifically, the light of the wavelength band corresponding to the second sensor 32 is transmitted through both the first filter area 11 of yellow and the second filter area 12 of cyan. The light of the wavelength band corresponding to a first sensor 31 is transmitted through the first filter area 11 of yellow, and is not transmitted through the second filter area 12 of cyan. The light of the wavelength band corresponding to the third sensor 33 is transmitted through the second filter area 12 of cyan, and is not transmitted through the second filter area 12 of yellow.

The fact that the light of a certain wavelength band is transmitted through a filter or a filter area means that the light of the wavelength band is transmitted through the filter or the filter area at a high transmittance and the attenuation of light in the wavelength band (i.e., a reduction in the light amount) caused by the filter or the filter area is extremely small. In addition, the fact that the light of a certain wavelength band is not transmitted through a filter or a filter area means that the light is blocked by the filter or the filter area, for example, the light of the wavelength band is transmitted through the filter or the filter area at a low transmittance and the attenuation of light in the wavelength band caused by the filter or the filter area is extremely large. For example, the filter or the filter area attenuates the light by absorbing the light of a certain wavelength band.

FIG. 3 is a graph showing an example of transmittance characteristics of the first filter area 11 and the second filter area 12. As shown in FIG. 3, according to a transmittance characteristic 21 of the first filter area 11 of yellow, the light of she wavelength band corresponding to the R image and the G image is transmitted at high transmittance, and the light of the wavelength band corresponding to the B image is hardly transmitted. In addition, according to transmittance characteristic 22 of the second filter area 12 of cyan, the light of the wavelength band corresponding to the B image and the G image is transmitted at a high transmittance, and most of the light of the wavelength band corresponding to the R image is not transmitted.

Therefore, since the light of the wavelength band corresponding to the R image is transmitted through the only first filter area 11 of yellow and the light of the wavelength band corresponding to the B image is transmitted through the only second filter area 12 of cyan, the shape of the blur on the R image and the B image changes in accordance with the distance d to the object, more specifically, the difference between the distance d and the focal length d_{f}. In addition, since each of the filter areas is asymmetric about the optical center, the shape of the blur on the R image and the B image is varied in accordance with the object located in front of or behind the focal length d_{f}. In other words, the shape of the blur on the R image and the B image is deviated.

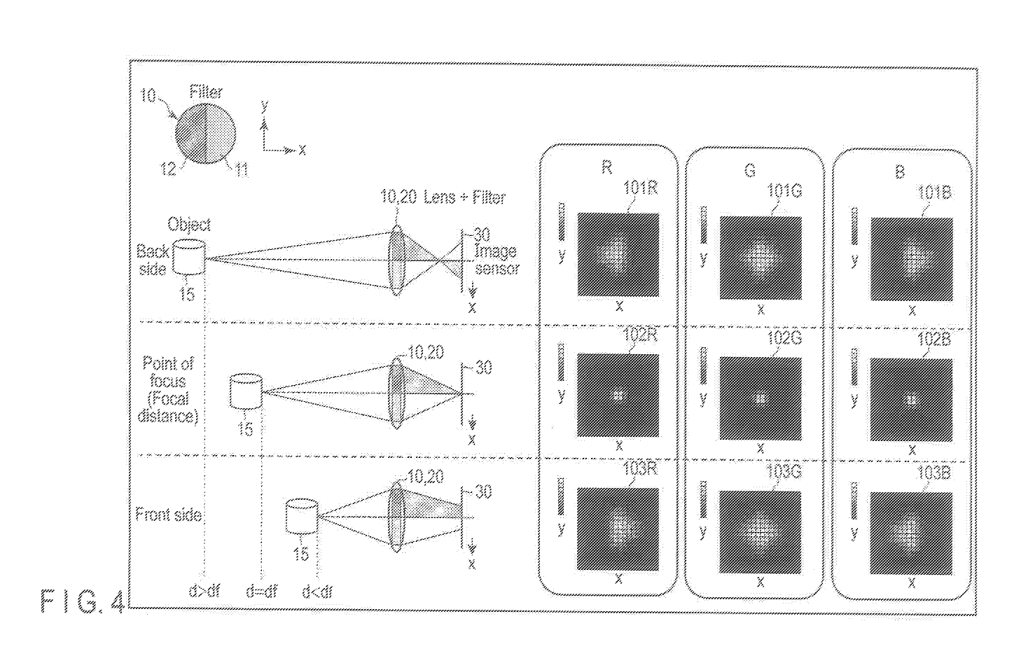

The change in light beats caused by the color-filtered aperture where the filter 10 is disposed, and the blur shape will be explained with reference to FIG. 4.

If the object 15 is located behind focal length d_{f} (d>d_{f}), blur occurs in the image captured by the image sensor 30. Blur functions (PSF: Point Spread Function) indicating the shape of the blur on the image are different in the R image, the G image, and the B image, respectively. In other words, a blur function 101R of the R image indicates the shape of the blur deviated to the left side, a blur function 101G of the G image indicates the shape of the blur having no deviation, and a blur function 101B of the B image indicates the shape of the blur deviated to right side.

If the object 15 is in the focal length d_{f} (d=d_{f}), blur hardly occurs in the image captured by the image sensor 30. The blur function indicating the shape of the blur on the image is approximately the same in the R image, the G image, and the B image. In other words, the blur function 102R of the R image, the blur function 102G of the G image, and the blur function 102B of the B image indicate the shape of the blur having no deviation.

If the object 15 is in front of the focal length d_{f} (d<d_{f}), blur occurs in the image captured by the image sensor 30. The blur functions indicating the shape of the blur on the image are different in the R image, the G image, and the B image, respectively. In other words, a blur function 103R of the R image indicates the shape of the blur deviated to the right side, a blur function 103G of the G image indicates the shape of the blur having no deviation, and a blur function 103B of the B image indicates the shape of the blur deviated toward the left side.

In the embodiments, the distance to the object is calculated by using the characteristics.

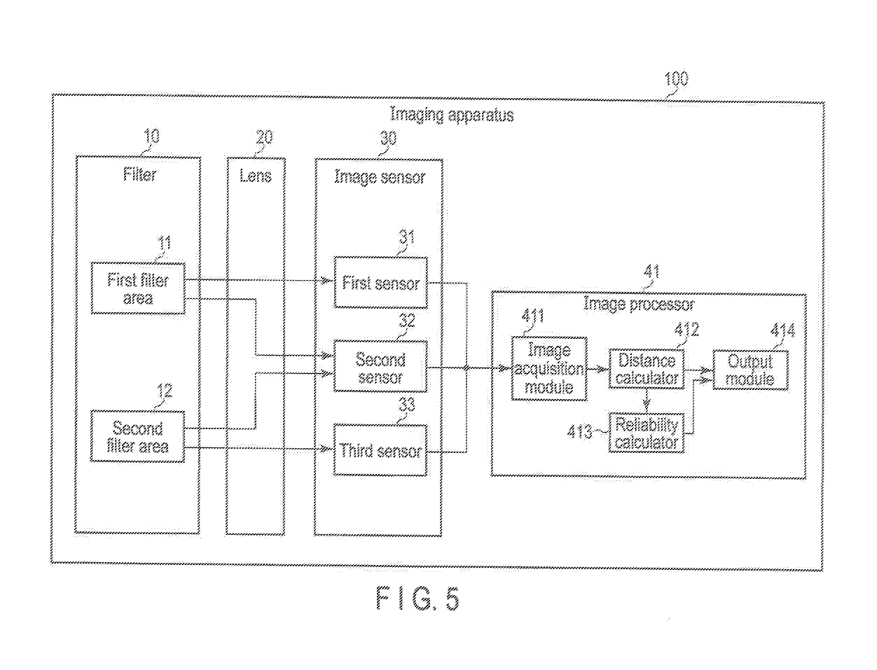

FIG. 5 is a block diagram showing an example of functional configuration of the imaging apparatus 100.

As shown in FIG. 5, the imaging apparatus 100 includes an image processor 41 in addition to the filter 10, the lens 20, and the image sensor 30 explained above. An arrow from the filter 10 to the image sensor 30 indicates a path of the light. An arrow from the image sensor 30 to the image processor 41 indicates a path of an electrical signal. The image processor 41 includes, for example, an image acquisition module 411, a distance calculator 412, a reliability calculator 413, and an output module 414. In the image processor 41, several or all the portions may be implemented by software (programs) or hardware circuits.

The image acquisition module 411 acquires the G image in which the blur function (point spread function, PSF) indicates the shape of the blur having no deviation as a reference image. In addition, the image acquisition module 411 acquires one or both of the R image and the B image representing the shape of the blur in which the blur function is deviated, as a target image or target images. For example, the target image and the reference image are images captured at the same time by one imaging apparatus.

The distance calculator 412 calculates a distance to the object on the image by obtaining a convolution kernel in which correlation with the reference image becomes higher if added to the target image, of a plurality of convolution kernels. The distance calculator 412 may further output the distance image from the calculated distance. The convolution kernels are functions which add different blur to the target image. First, details of the distance calculation processing executed by the distance calculator 412 will be explained.

The distance calculator 412 generates a correction image where a correction is made to the shape of a blur of the target image by adding a different blur to the target image based on the acquired target image and reference image. In the embodiments, the distance calculator 412 generates a corrected image in which the blur shape of the target image is corrected by using the convolution kernels generated by assuming that the distance to the object on the image is an arbitrary distance, obtains the distance in which the correlation between the corrected image and the reference image becomes higher, and calculates the distance to the object. A manner of calculating the correlation between the corrected image and the reference image will be explained later.

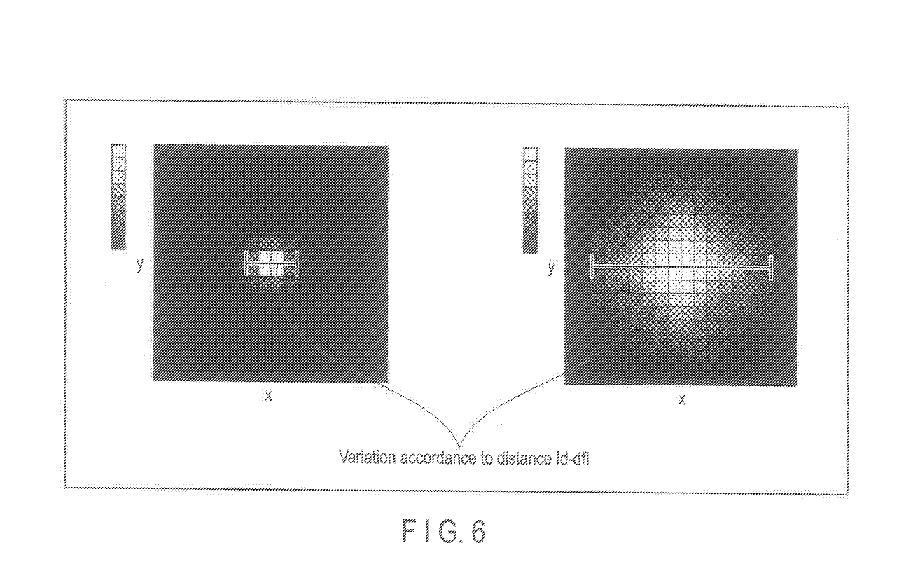

The blur function of the captured image is determined based on the aperture shape of the imaging apparatus 100 and the distance between the object's position and focus position. FIG. 6 is an illustration showing an example of the blur function of the reference image according to the embodiments. As shown in FIG. 6, since the aperture shape through which the wavelength range corresponding to the second sensor is transmitted is a circular shape having a point symmetry, the shape of the blur indicated by the blur function is not varied before and behind the focus position, but the width of the blur changes is varied in accordance with the magnitude of distance between the object and the focus position. The blur function indicating the blur shape can be represented as a Gaussian function in which the width of the blur is varied in accordance with the magnitude of distance between the object's position and the focus position. The blur function may be represented as a pill-box function in which the width of the blur is varied in accordance with the distance between the object's position and the focus position.

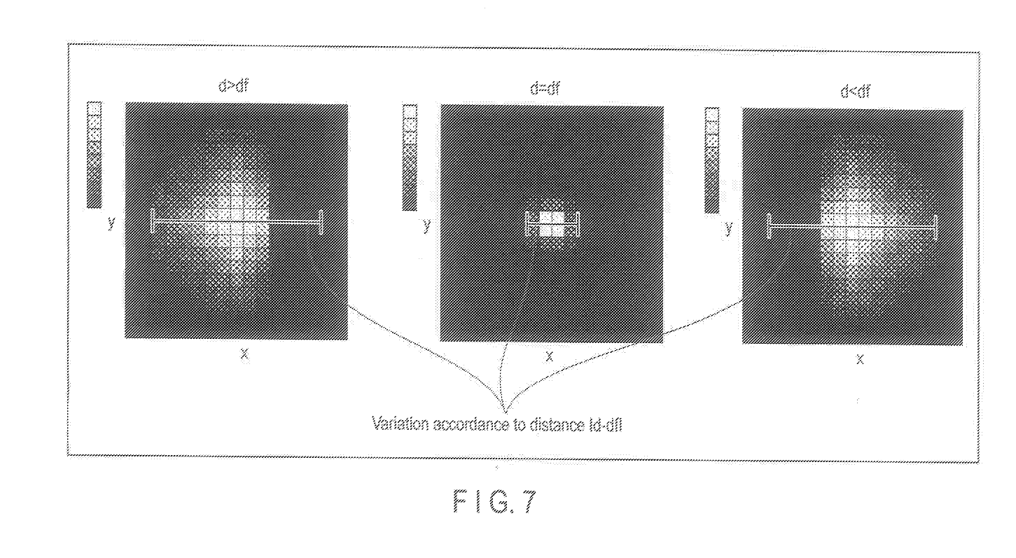

In contrast, FIG. 7 is an illustration showing an example of the blur function of the target image according to the embodiments. In each graph, coordinates of the center (x₀, y₀) are (0, 0). As shown in FIG. 7, in a case where d>d_{f} in which she object is more distant from the focus position, the blur function of the target image (for example, R image) can be expressed as a Gaussian function in which the width of the blur is attenuated due to attenuation of the light in the first filter area 11 at x>0. In addition, in a case where d<d_{f} in which the object is closer than the focus position, the blur function can be expressed as a Gaussian function in which the width of a blur is attenuated due to attenuation of the light in the first filter area 11 at x<0.

In addition, it can ask for the a plurality of convolution kernels for rectifying the blur form of a target image to the blur form of a reference image by analyzing the blur function of a reference image, and the blur function of a target image.

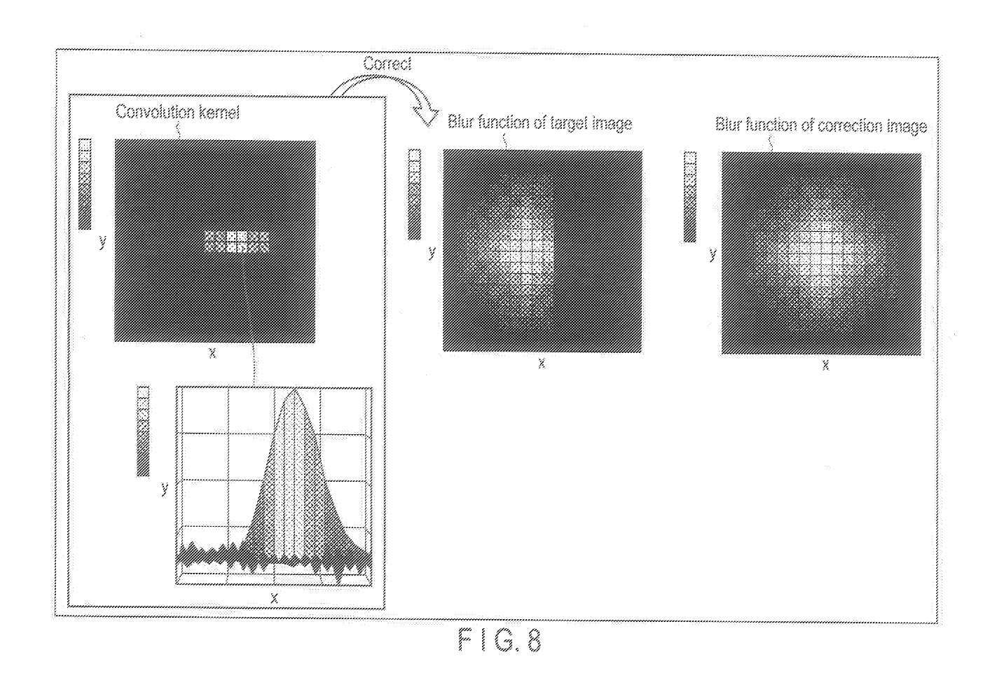

FIG. 8 is an illustration showing an example of the convolution kernel according to the embodiments. The convolution kernel shown in FIG. 8 is a convolution kernel in the case of using the filter 10 shown in FIG. 2. As shown in FIG. 8, the convolution kernel passes at the central point of the line segment of the boundary between the first filter area 11 and the second filter area 12, and distributes on the straight line orthogonal to the line segment (near a straight line). The distribution is a mountain-shaped distribution as shown in the drawing, in which the peak point (position on the line x, height) and the expansion from the peak point are different for each assumed distance. The blur shape of the target image can be corrected to various blur shapes assuming an arbitrary distance, by using the convolution kernel. In other words, a corrected image can be generated while assuming the arbitrary distance.

The distance calculator 412 obtains the distance in which the blur shapes of the generated corrected image and the reference image become most approximate or match, from each pixel of the captured image. The correlation between the corrected image and the reference image in the square area of an arbitrary sire about each pixel may be calculated as the degree of matching of the blur shapes. The calculation of the degree of matching of the blur shapes may employ an existing similarity evaluation method. The distance calculator 412 obtains the distance in which the correlation between the corrected image and the reference image becomes highest, and calculates the distance to the object reflected on each pixel.

For example, Sum of Squared Difference (SSD), Sum of Absolute Difference (SAD), Normalized Cross-Correlation (NCC), Zero-mean Normalized Cross-Correlation (ZNCC), Color Alignment Measure, and the like may be employed as the existing similarity evaluation methods. In the embodiments, Color Alignment Measure using the color components of a natural image which have a characteristic of having a locally linear relationship is employed. In Color Alignment Measure, the index indicating the correlation is calculated from dispersion of the color distribution of a local boundary area about the target pixel of the captured image.

Thus, the distance calculator 412 generates the corrected image by correcting the blur shape of the target image according to the filter area with the convolution kernel assuming the distance, obtains the distance in which the correlation between the generated corrected image and the reference image becomes higher, and thereby calculates the distance to the object.

The reliability calculator 413 calculates the reliability of the distance calculated by the distance calculator 412 as mentioned above. Next, details of the reliability calculation executed by the reliability calculator 413 will be explained.

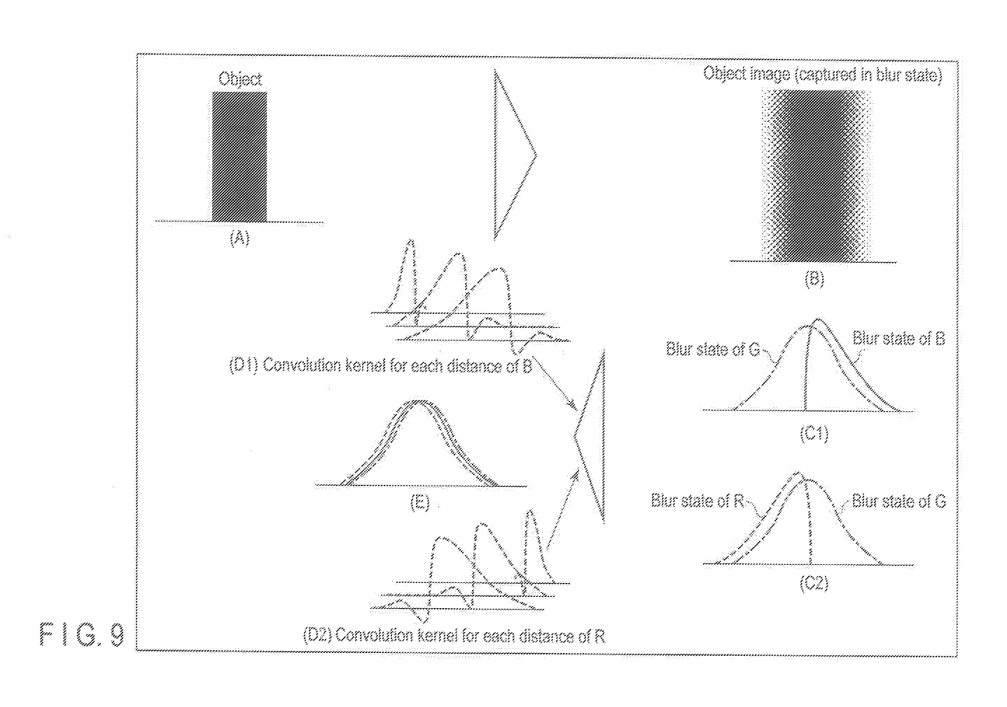

For example, as shown in FIG. 9, if a position of object (A) is more distant than the focus position, the blur of an object image (B) is deviated toward the right side in the B image (C1) and deviated toward the left side in the E image (C2). In the G image, laterally symmetrical blur appears. In addition, horizontal axes of object (A) and object image (B) in FIG. 9 exist in the same dimension as horizontal axes of C1, C2, D1, D2, and E. Each of vertical axes of C1, C2, D1, and D2 indicate the quantity of the color components of the blur.

Thus, the distance to object (A) can be acquired by searching an optimal convolution kernel of the convolution kernels (D1 and D2) for each distance in order to urge the blur shape of one or both of the B image and the R image to match the blur shape of the G image (E).

FIG. 10 is an illustration showing the blur shapes (C1, C2) of the object image (B) shown in FIG. 9 and the corrected blur shape (E) as sectional waveforms. As shown in FIG. 11, a search problem of searching for the blur correction amount (A1, A2) to make the blur shape of one or both of the B image and the R image match the blur shape of the G image is a convex optimization problem. In other words, the correlation function of the blur shapes of the B image and the R image corrected with the convolution kernels (FIG. 9: D1, D2) for each distance and the blur shape of the G image becomes a convex function.

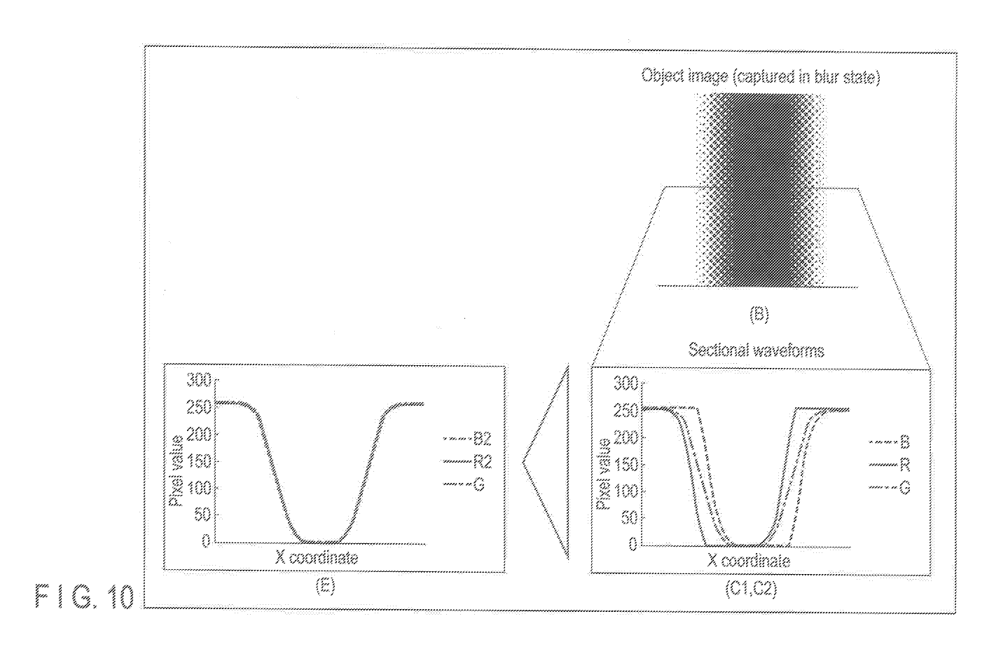

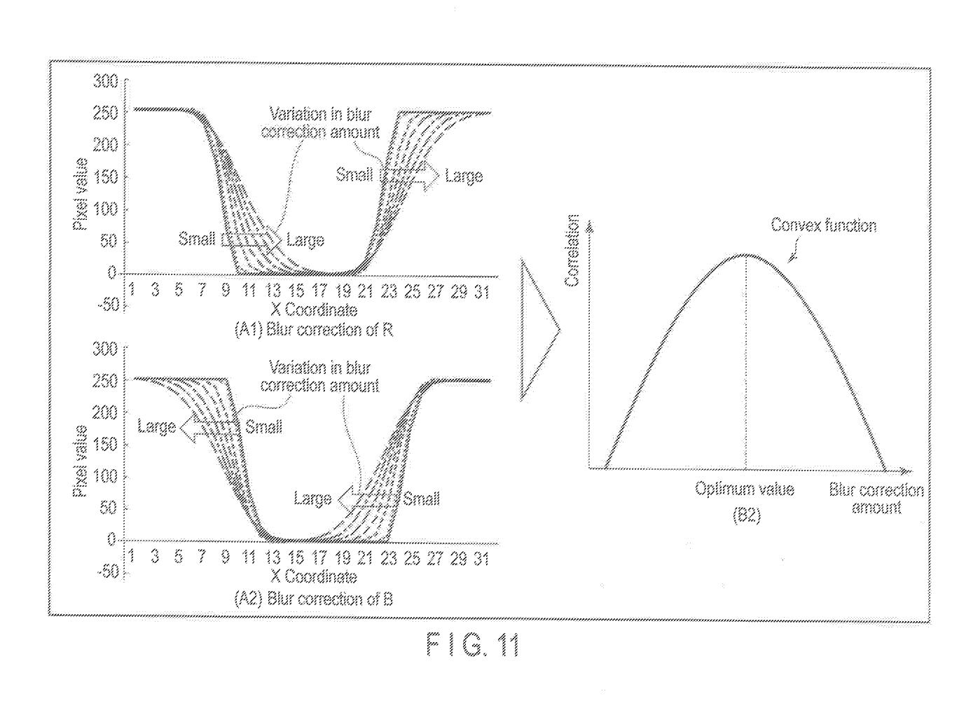

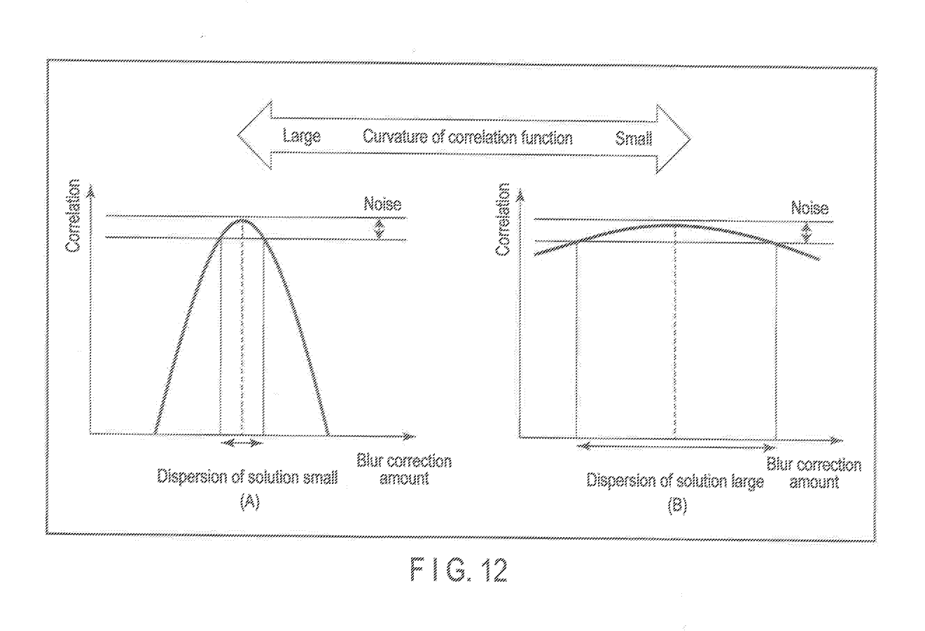

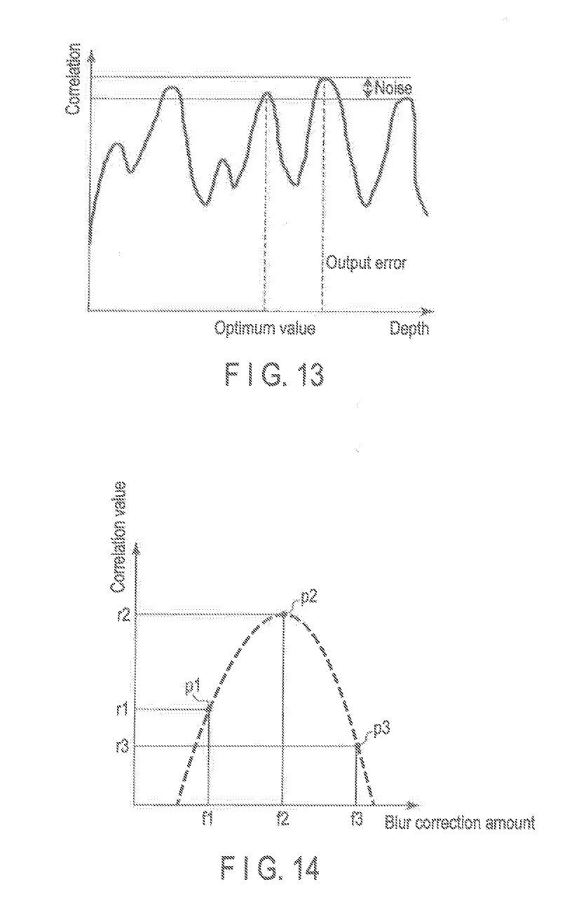

In addition, the curvature of the correlation function which is the convex function becomes large if the number of the convolution kernels in which the correlation value larger than or equal to a threshold value can be obtained, i.e., if dispersion in a solution is small, or becomes small if dispersion in a solution is large, as shown in FIG. 12. The reliability calculator 413 calculates the reliability of the distance calculated by the distance calculator 412, based on the curvature of this correlation function. In contrast, if the distance to the object is calculated from two images by stereo matching, the search problem of searching for the corresponding points on the image corresponding to a notice point on the other image is not a convex optimization problem as shown in, for example, FIG. 13. Therefore, the reliability of distance can hardly be obtained from a correlation value, in stereo matching.

An example of a method of calculating the curvature of the correlation function will be explained with reference to FIG. 14.

For example, a quadratic function is subjected to fitting (least square method) as a curve obtained from each correlation value (rₙ) at the time of applying the convolution kernel (fₙ) for each distance, and the curvature of the correlation function is considered as a quadratic coefficient of the quadratic function. In this case, the curvature can be calculated from three points (p₁, p₂, and p₃).

More specifically, the following expressions of the points (p₁, p₂, and p₃) are formulated and the values a, b and c are calculated from the expressions.

r₁=c+bf₁+af₁² (expression 1)

r₂=c+bf₂+af₂² (expression 2)

r₃=c+bf₃+af₃² (expression 3)

In other words, the quadratic coefficient considered as the curvature, a, is calculated.

In addition, the curvature thus calculated is converted into, for example, reliability (0-1) by the following (expression 4) using a Gaussian function.

Reliability=1−exp(−(curvature²/2σ²)) (expression 4)

The reliability calculator 413 acquires from the distance calculator 412 the correlation value at application of the convolution kernel for each distance calculated in the process of calculating the distance to the object, and calculates the reliability of the distance calculated in, for example, the above-explained method, by the distance calculator 412.

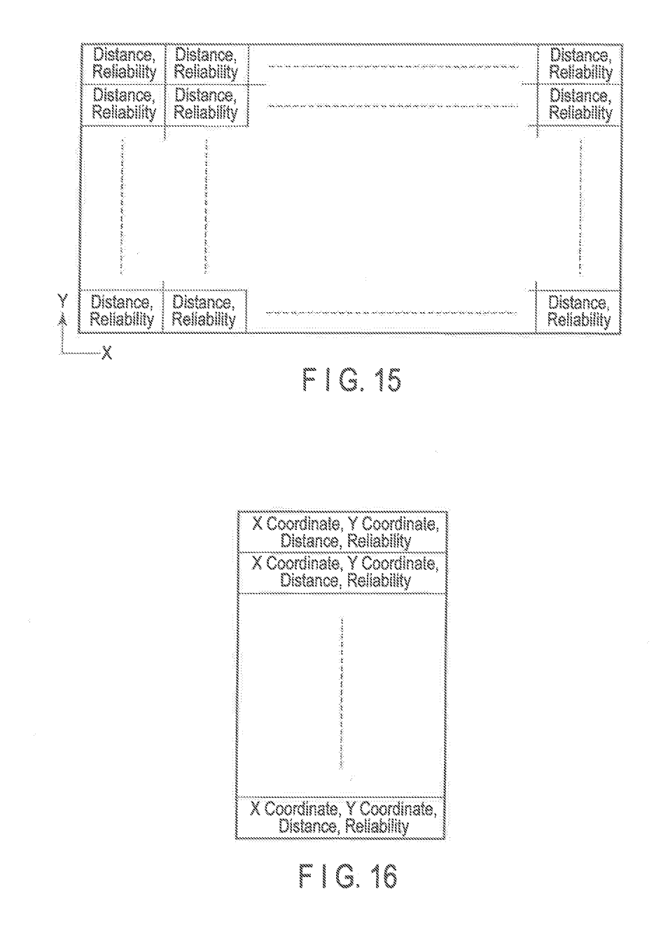

The output module 414 outputs the output data which associates the distance calculated by the distance calculator 412 with the reliability of the distance calculated by the reliability calculator 413. As shown in FIG. 15, for example, the output module 414 outputs the distance calculated per pixel and the reliability of the distance, in a map form in which the distance and the reliability are arranged to positionally correspond to the image. Alternatively, as shown in FIG. 16, for example, the output module 414 may output the distance calculated per pixel and the reliability of the distance, in a list form in which the distance and the reliability are arranged in order based on coordinates set on an image. The output module 414 may output the distance calculated per pixel and the reliability of the distance in not only the form shown in FIG. 15 and FIG. 16 but any form.

For example, the distance (distance map) and the reliability (reliability map) may be output separately in a map form as explained above. Furthermore, either or both of the two-map data may be coupled to three-image data of RGB as output data. Alternately, either or both of the two-map data may be coupled to three data elements of YUV (luminance signal, chrominance signal [Cb], chrominance signal [Cr]).

Moreover, for example, the distance (distance list) and the reliability (reliability list) may be output separately in a list form as explained above. Furthermore, either or both of the two-list data may be coupled to the three-image data of RGB as the output data. Alternately, either or both of the two-list data may be coupled to three data elements of YUV.

In addition, a mode of outputting the reliability may be, for example, a display which shows the reliability in a pop-up form when the position on the distance image is designated. The distance at the position designated on the distance image may be displayed in a pop-up form. The distance information and the reliability may be displayed on a color image in a pop-up form.

The distance may not be calculated for all the pixels in the image. For example, the object which is an object for detection of the distance may be specified preliminarily. The designation can be executed by, for example, image recognition or specification conducted by user input. Similarly, the reliability may not be calculated for all the pixels having the distances required, either. For example, the reliability of a specific object and a close object may be calculated and the reliability of a distant object may not be calculated.

The output data may not include all the calculated distances in a case of simultaneously outputting the distance and the reliability as shown in FIG. 15 or outputting the distance map and the reliability map separately, in the map form as explained above, and a case of simultaneously outputting the distance and the reliability as shown in FIG. 16 or outputting the distance list and the reliability list separately, in the list form as explained above. For example, if the reliability is lower than a predetermined value or the reliability is relatively low, the distance may not be included in the output data.

The output data which can be output in various forms such as the map and the list may be output to, for example, the display 70.

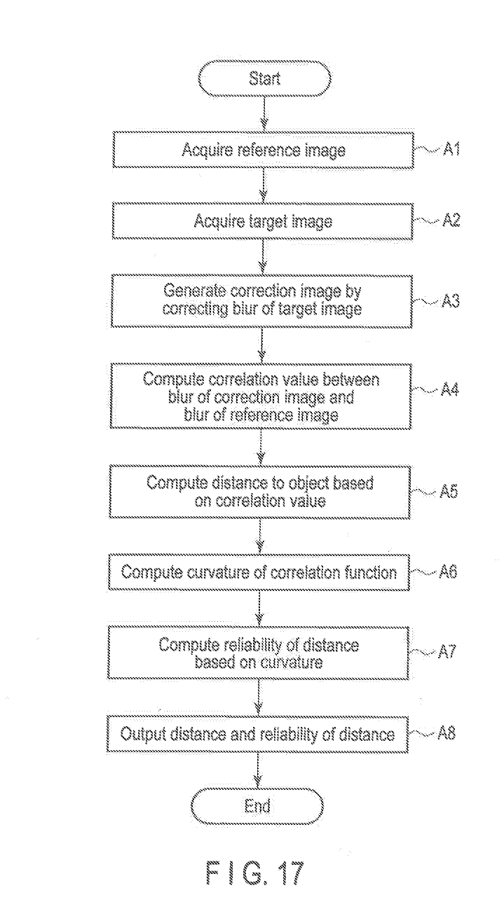

FIG. 17 is a flowchart showing an example of a flow of the image processing in the embodiments.

The image acquisition module 411 acquires the image generated by the image sensor 30, which is the reference image formed by the light transmitted without being attenuated in the first filter area or the second filter area, of the light transmitted through the filter area of the filter 10 (step A1). In addition, the image acquisition module 411 also acquires the image generated by the image sensor 30, which is the target image formed by the light transmitted by being attenuated in, for example, the first filter area, of the light transmitted through the filter area of the filter 10 (step A2). The image formed by the light transmitted by being attenuated in the first filter area is assumed as the target image, but the image acquisition module 411 may acquire the image formed by the light transmitted by being attenuated in the second filter area or may acquire both the image formed by the light transmitted by being attenuated in the first filter area and the image formed by the light transmitted by being attenuated in the second filter area.

The distance calculator 412 generates the corrected image obtained by correcting the blur shape of the target image by using the convolution kernel (step A3), and calculates the correlation value between the blur of this corrected image and the blur of the reference image (step A4). The generation of the corrected image and the calculation of the correlation value are executed to the number of the convolution kernel for each distance. The distance calculator 412 calculates the distance to the object, based on the calculated correlation value (step A5). More specifically, the distance calculator 412 acquires the distance to the object by searching the convolution kernel having the highest correlation between the generated corrected image and the reference image, of the convolution kernels for each distance. Alternately, the distance calculator 412 may search the convolution kernel generating the corrected image of higher correlation with the reference image and the like than the other correction filters.

In addition, the reliability calculator 413 calculates the curvature of the correlation function, based on the correlation value at application of the convolution kernel processing for each distance calculated in the process of calculating the distance to the object (step A6). The reliability calculator 413 calculates the reliability of the distance calculated by the distance calculator 412, based on the calculated curvature (step A7).

Then, the output module 414 outputs the distance calculated by the distance calculator 412 and the reliability of the distance calculated by the reliability calculator 413 in association with each other (step A8).

According to the embodiments, as explained above, the reliability of the distance to the object acquired from the image can be calculated as a value reflecting actual reliability.

Incidentally, the curvature of the correlation function between the corrected image generated by the convolution kernel for each distance and the reference image is calculated, and this curvature is converted into the reliability of distance, in the above explanations. The calculated correlation value itself may be considered as the reliability of distance by recognizing the correlation value between the corrected image and the reference image as probability (0-1) that the distance associated with the convolution kernel used for generation of the corrected image is a correct value. More specifically, the correlation value of the convolution kernel having the highest correlation between the corrected image and the reference image, of a plurality of convolution kernels, may be considered as the reliability of distance.

For example, when the curvature is converted into the reliability of distance, the highest correlation value may be used as a weight and the reliability of distance may be set to be higher as the correlation value is higher. Alternatively, the edge direction of the object image, more specifically, the edge inclination direction of the pixel considered as a processing target may be used as a weight, and the reliability of distance may be set to be higher as the direction is more similar to the direction of the boundary line between the first filter area and the second filter area of the filter 10. Even when the correlation value itself is considered as the reliability of distance, the edge direction of the object image may be used as a weight. Alternatively, the edge strength of the object image, more specifically, the edge inclination strength of the pixel considered as a processing target may be used as a weight and the reliability of distance may be set to be higher as the strength is larger.

The example of calculating the distance to the object from the image by varying the blur function of the image by the filter 10 has been explained above but, two images in which at least one of the blur function is varied can be acquired without using the filter 10 and the distance can be calculated from correlation between the blur forms of the images if, for example, an image sensor called a 2PD sensor or the like, which divides the received incident light into two parts, i.e., right and left parts for each pixel is used. In this case, too, the above-explained manner of calculating the reliability of distance can be employed.

Next, several examples of a system employing the imaging apparatus 100 configured as explained above to output the distance to the object and the reliability of the distance will be explained.

### Automatic Control System: Robot

FIG. 18 is a block diagram showing a functional configuration example of a robot 200 according to the embodiments. The robot 200 is assumed to be, for example, an industrial robot installed in a production line and the like in which a plurality of types of products can be manufactured. The robot 200 is not limited to an installed type but may also be for example, an autonomously movable type such as an automatic guided vehicle (AGV) and the like. In addition, the robot 200 can also be implemented as, for example, non-industrial robots such as a robot vacuum cleaner for cleaning a floor and a communication robot providing visitors with various types of guidance.

As shown in FIG. 18, the robot 200 comprises the imaging apparatus 100, a controller 201, a drive mechanism 202, and a rotation mechanism 203. The imaging apparatus 100 is attached to the rotation mechanism 203.

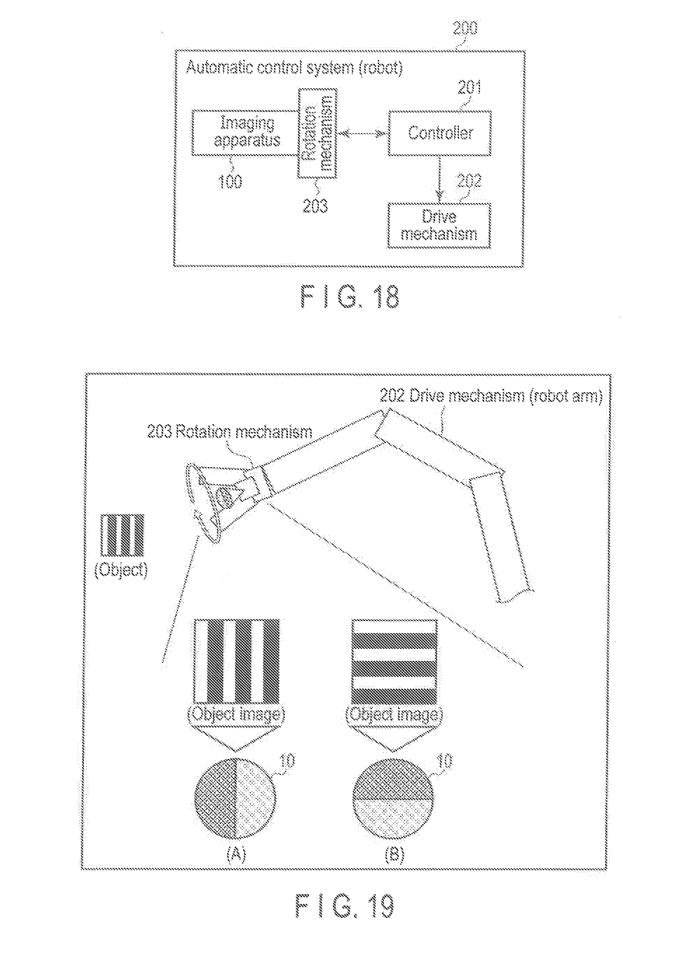

First, the controller 201 controls the drive mechanism 202, based on the distance to the object, i.e., a target of work, which is output from the imaging apparatus 100. The drive mechanism 202 is, for example, a robot arm for attaching as member to a target or picking up a target or conveying the target to a predetermined place. Secondly, the controller 201 controls the rotation mechanism 203, based on the reliability of the distance output from the imaging apparatus 100 together with the distance. FIG. 19 is an illustration for explanation of controlling the rotation mechanism 203 by the controller 201.

In general, the reliability of distance becomes high if an edge direction of an object image matches a direction of a boundary between the first filter area and the second filter area of the filter 10. In contrast, the reliability of distance becomes low when these directions are orthogonal to each other. Then, the controller 201 controls the rotation mechanism 203 such that the reliability of the distance output from the imaging apparatus 100 becomes high. More specifically, the controller 201 controls the rotation mechanism 203 such that the boundary between the first filter area and the second filter area of the filter 10 extends in a vertical direction if a number of edges of the object images appear in the vertical direction as shown in, for example, (A) due to the shape, pattern, orientation of arrangement of the object, while the controller 201 controls the rotation mechanism 203 such that the boundary between the first filter area and the second filter area of the filter 10 extends in a horizontal direction if, for example, a number of edges of the object images appear in the horizontal direction as shown in, for example, (B).

For example, first, the controller 201 urges the imaging apparatus 100 to execute pre-imaging, and derives the angle of rotation at which the imaging apparatus 100 should be rotated by the rotation mechanism 203, based on the reliability of the distance output from the imaging apparatus 100 at the pre-imaging. In the pre-imaging, the imaging apparatus 100 may not calculate the distance and the reliability of distance for all the pixels on the image, but may calculate the distance and the reliability of the distance for a certain number of pixels sampled. In addition, for example, the controller 201 uses these average values as the reliability of the distance in the pre-imaging. As the method of deriving the angle of rotation, for example, various methods such as a method of setting the angle of rotation as 90 degrees if the reliability of the distance in a pre-imaging is less than a threshold value can be employed. After rotating the imaging apparatus 100 by the rotation mechanism 203, the controller 201 urges the imaging apparatus 100 to execute the imaging.

Alternatively, the controller 201 may urge the imaging apparatus 100 to sequentially capture images while rotating the imaging apparatus 100 by the rotation mechanism 203, and may adopt an image of the highest reliability of distance.

FIG. 19 shows an example of providing the rotation mechanism 203 on the drive mechanism 202, but providing the imaging apparatus 100 on the drive mechanism 202 is not indispensable and the rolling mechanism 203 may be therefore provided independently of the drive mechanism 202.

The manner of rotating the imaging apparatus 100 such that the reliability of distance becomes high can also be applied to a mobile object other than the robot 200. If the mobile object is, for example, a rotatable flying object such as a drone, the controller 301 may control the drive mechanism 302 to rotate the entire body of the mobile object 300 irrespective of the rotation mechanism.

The imaging apparatus 100 may comprise a rotation mechanism configured to rotate the filter 10 about the image sensor 30. The rotation mechanism rotates one filter in one plane about, for example, the optical center. The distance of high reliability can be acquired by the rotation of the filter 10.

### Automatic Control System: Mobile Object

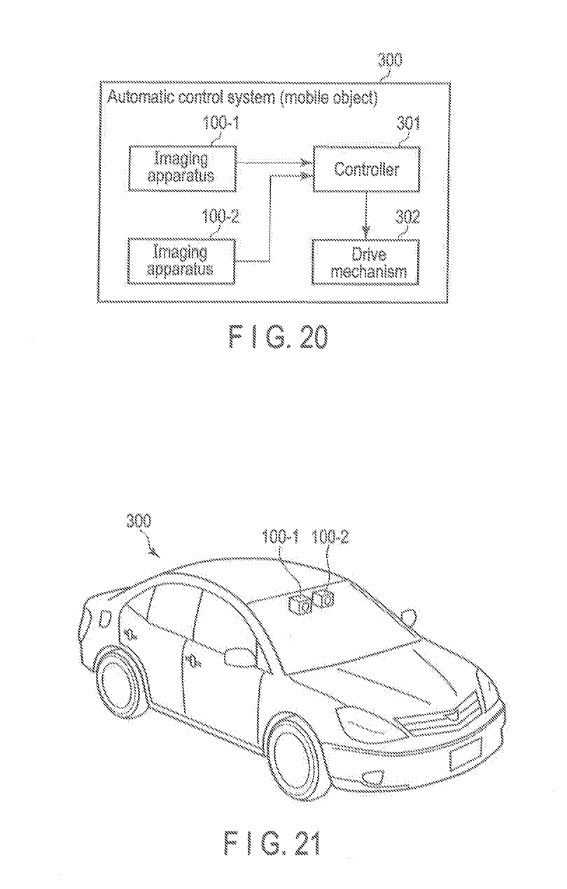

FIG. 20 is a block diagram showing a functional configuration example of a mobile object 300 according to the embodiments. The mobile object 300 is assumed to be, for example, a vehicle. The mobile object 300 is not limited to a vehicle such as a car, but can be implemented as a flying object such as a drone and an airplane, a vessel, a robot such as AGV and a robot vacuum cleaner, and various bodies, comprising the drive mechanism for movement. Furthermore, the mobile object 300 may be an automatic door.

As shown in FIG. 20, the mobile object 300 comprises a control system. The control system comprises two imaging apparatuses 100 (100-1 and 100-2), a controller 301, and a drive mechanism 302. The control system is assumed to comprise two imaging apparatuses 100 but may comprise three or more imaging apparatuses 100. The control system may be built in the mobile object 300 or may execute remote control of the mobile object. The controller 301 may control the drive mechanism 302 directly or indirectly by radio waves. As shown in FIG. 21, two imaging apparatuses 100 are, for example, provided to capture the object in the advancing direction of the mobile object 300. As a mode of being installed to capture the object in the direction of movement of the mobile object 300, the imaging apparatuses can be installed as what is called front cameras to capture the front side or can be installed as what is called rear cameras to capture the rear side. Of course, both of these may be installed. In addition, the image devices 100 may be installed while comprising a function of what is called a drive recorder. In other words, the imaging apparatuses 100 may be video recorders.

The controller 201 controls the drive mechanism 302, based on the distance and the reliability output from each of the imaging apparatuses 100. For example, the controller 201. controls the drive mechanism 302, based on the distance of higher reliability, of the distances acquired from the imaging apparatuses 100. Alternatively, the controller 201 controls the drive mechanism 302, based on distances obtained by weighting the distances obtained from the respective imaging apparatuses 100 with the reliability. The control is, for example, to stop, decelerate or accelerate the mobile object 300 if the mobile object 300 approaches the object in the direction of movement in a predetermined distance, and to urge the stopping mobile object 300 to start moving. Alternatively, the controller 201 may control the drive mechanism 302 to urge the mobile object 300 to stop, decelerate, accelerate and start movement if the object is distant in a predetermined distance or more. Alternatively, the controller 201 may control the drive mechanism 302 to change from a general drive mode to a collision avoidance mode if the mobile object approaches the object in a predetermined distance or to change from the collision avoidance mode to the general drive mode if the object is distant in a predetermined distance or more. A predetermined distance may be varied in accordance with, for example, the reliability.

The reliability may be obtained in an image unit or an area unit on the image. In the former case, for example, the image of a higher average of the reliability of distance is adopted. In the latter case, for example, reliability values of distance are compared for each corresponding pixel between two images, and the image of the higher value is adopted. The distance to the object can be thereby acquired more correctly. The drive mechanism is, for example, a motor or an engine for driving a tire, a roller, and a propeller.

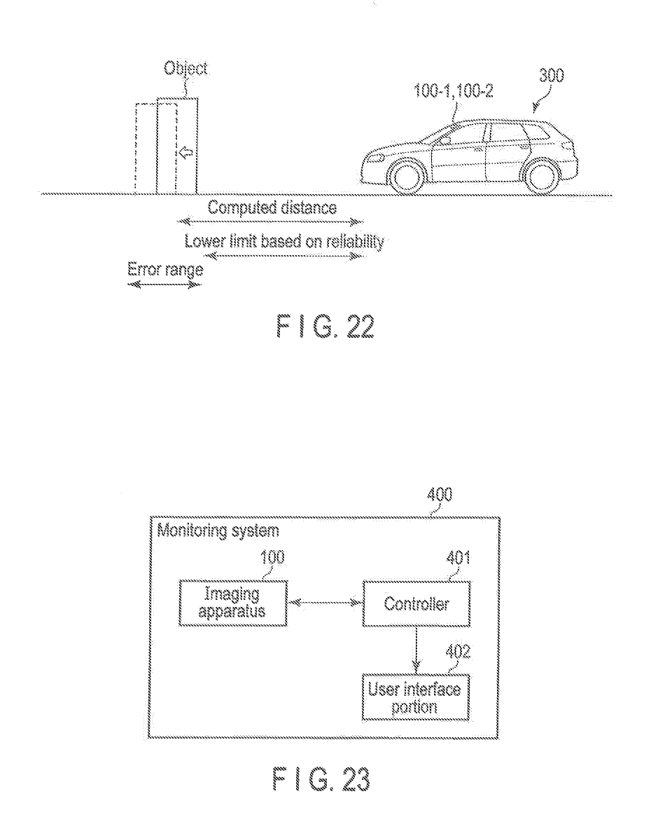

Then, an example of practical use of the reliability of the distance in the mobile object 300 will be explained with reference to FIG. 22.

It is assumed here that the controller 201 controls the drive mechanism 302 to stop the mobile object 300 if the mobile object 300 approaches the object in the direction of movement in a predetermined distance as one of the controls of the drive mechanism 302. When the controller 201 acquires the distance to the object and the reliability of the distance from the imaging apparatuses 100, the controller 201 calculates a lower limit of the distance which is one of ends of an error range, based on the distance and the reliability of the distance. The controller 201 controls the drive mechanism 302 by using not the distance output from the imaging apparatuses 100 but the lower limit of the distance. The lower limit is calculated as a value of a smaller difference from the distance as the reliability of the distance is higher and calculated as a value of a larger difference from the distance as the reliability of the distance is lower.

For example, even if a distance longer than an actual distance to the object is calculated by the imaging apparatuses 100 and output as shown in FIG. 22, situation that stop, deceleration, collision avoidance and turn of the mobile object 300, operation of a safety device such as an air bag, and the like may be delayed can be prevented by using a lower limit of the distance calculated from the reliability of distance.

Use of the lower limit of the distance calculated from the distance and the reliability of distance may also be executed when one imaging apparatus 100 is provided. The present system is available for not only the mobile object 300, but, for example, the robot 200 explained with reference to FIG. 19 and FIG. 20, and the like.

### Monitoring Systems

FIG. 23 is a block diagram showing a functional configuration example of a monitoring system 400 according to the embodiments. The monitoring system 400 is assumed to be a system for recognizing, for example, flow of persons in a store or the like for each time zone.

As illustrated in FIG. 23, the monitor system 400 comprises the imaging apparatus 100, a controller 401, and a user interface portion 402. The imaging apparatus 100 and the controller 401 may be connected via a wired or wireless network.

The controller 401 urges the imaging apparatus 100 to sequentially capture images, and firstly displays the images captured by the imaging apparatus 100 via the user interface portion 402. The user interface portion 402 executes display processing on, for example, a display or the like and input processing from, for example, a keyboard or a pointing device. The display device and the pointing devices may be, for example, an integrated device such as a touchscreen display.

Secondly, the controller 401 analyzes the flow of persons, i.e., in which part of passage and which direction the persons are walking, based on the distance to the object and the reliability of the distance, which are sequentially output from the imaging apparatus 100, and records the analysis result in, for example, a storage such as a hard disk drive (HDD). This analysis does not necessarily need to be executed in real time, but may be executed as batch processing using the distance to the object and the reliability of the distance accumulated in the storage.

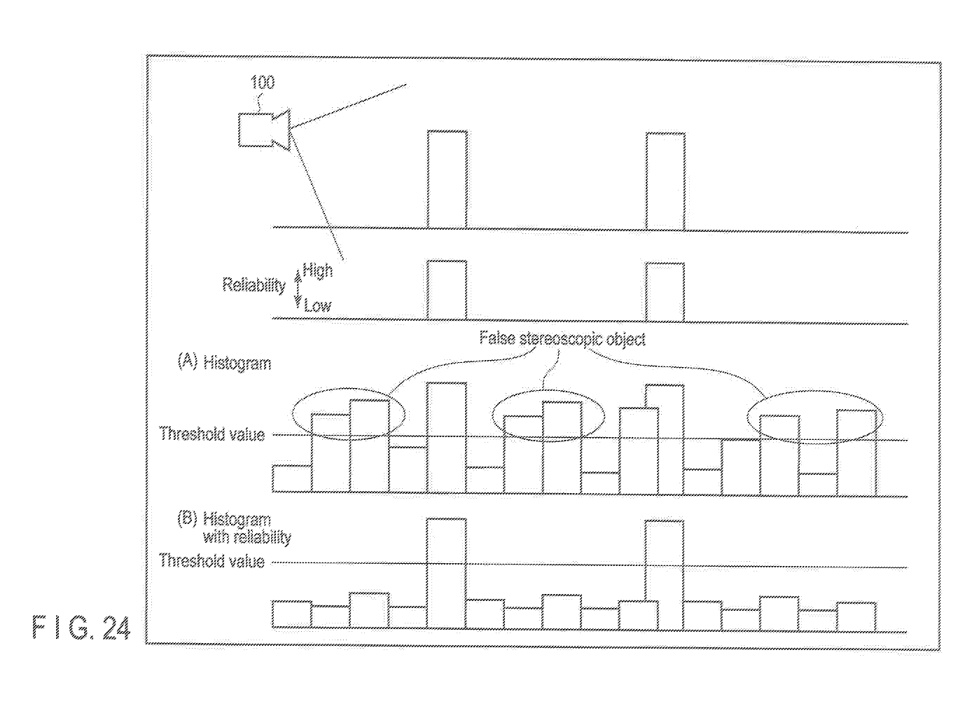

For example, two stereoscopic objects are assumed to be captured by the imaging apparatus 100 in a state of existing in a capture range as shown in FIG. 24. In addition, it is also assumed that an image on which an object similar to a stereoscopic object not in existence in fact is reflected can easily be captured for various reasons such as a background and an illumination. In this case, for example, if a stereoscopic object is recognized based on distribution of the distance in the image, an object similar to a stereoscopic object may be recognized as, for example, a tracking target, as shown (A) of FIG. 24.

For example, a situation that the object similar to a stereoscopic object may be misrecognized as a stereoscopic object can be prevented by excluding the distance of low reliability when the distribution of the distance in the image is calculated as shown (B) of FIG. 24.

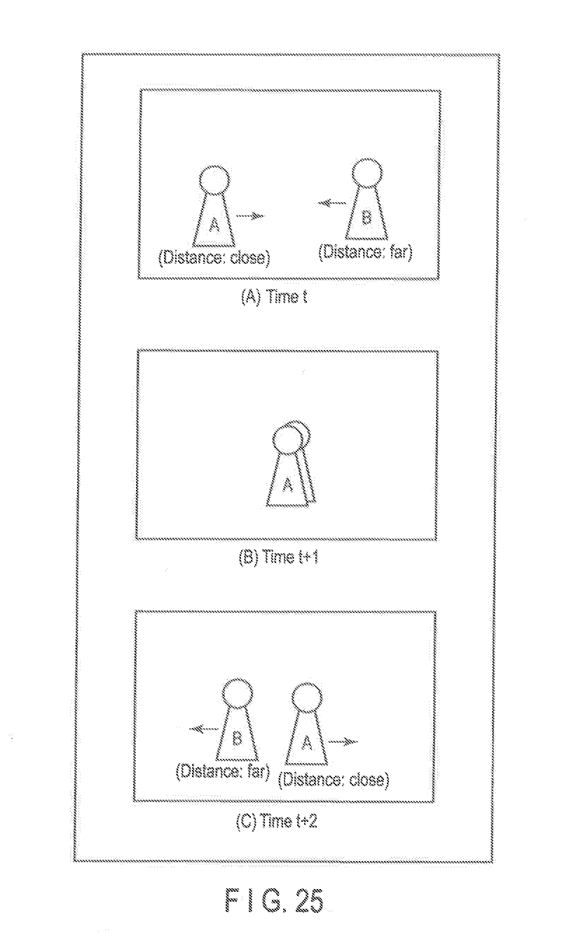

Then, an example of practical use of the distance in tracking the object image in the image recognized as explained above will be explained with reference to FIG. 25.

A certain person is assumed to move from the left side to the right side as seen from the imaging apparatus 100 and another person is assumed to move in an opposite direction, from the right side to the left side (A). In addition, it is assumed that these two persons are different height, the shorter person is located at a more forward side than the taller person as seen from the imaging apparatus 100 and the object images in the image approximately match in size as a result.

If these two persons continue moving as they are, the object images on the image overlap at a certain time (B) and then separate to the right and left sides (C). In this case, if the object images are tracked by, for example, image recognition alone without using the distance, the tracking target may be misrecognized when the object images cross, and two persons may be erroneously considered to return.

The situation that the tracking target may be misrecognized when the object images cross can be prevented by using the distance.

The other example of practical use of the distance in tracking the object image in the image recognized as mentioned above is, for example, an automatic door system which automatically opens the door when detecting the object moving toward the door and approaching in a predetermined distance, and which automatically closes the door when detecting the object moving to go away from the door and being distant from the door in a predetermined distance.

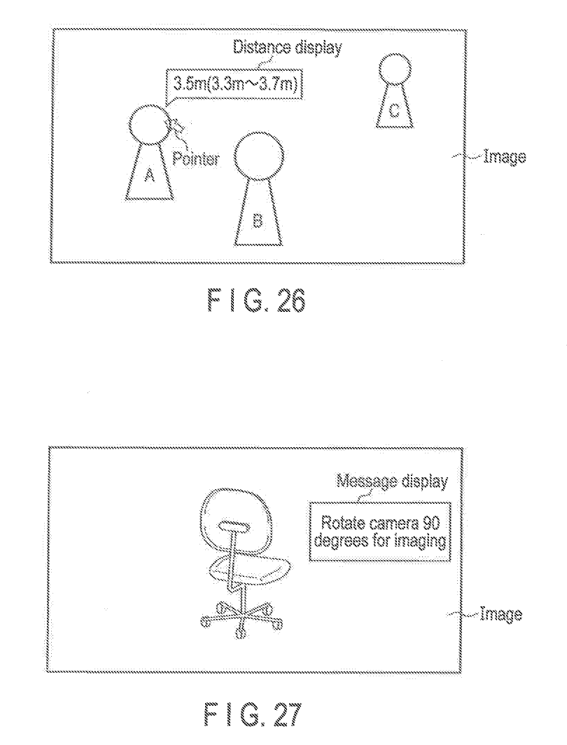

FIG. 26 is an illustration showing a distance presentation example using the reliability.

As explained above, the controller 401 displays the image captured by the imaging apparatus 100 via the user interface portion 402. The controller 401 acquires the distance to the object and the reliability of the distance from the imaging apparatus 100. Furthermore, for example, if an arbitrary position on an image is specified by a pointing device, the controller 401 receives event information including its coordinates from the user interface portion 402.

When receiving the event information, the controller 401 calculates both ends of an error range, i.e., a lower limit and an upper limit, based on the distance to the object and the reliability of the distance calculated by the imaging apparatus 100, of the pixel corresponding to the coordinates. Then, the controller 201 displays not only the distance, but also the range of the distance including an error, in a popup form, for example, near a pointer of a pointing device, via the user interface portion 402.

In other words, a graphical user interface (GUI) capable of presenting the distance to the object such that the error range can be recognized if the position on the image to which the object is reflected is indicated, can be provided.

Alternately, the user interface portion 402 may provide a GUI simultaneously displaying the display image and at least one of a G image in which blur having a lateral symmetry appears, a B image and an R image in which blur having a lateral asymmetry appears, and a color image (RGB image) and, if the position on the G image, the B image, the R image, or the color image is specified, displaying the distance and the reliability on the distance image.

In addition, such a GUI is also useful when an imaging apparatus is composed of a stand-alone type electronic device such as a tablet computer and a smartphone. For example, the GUI may be provided as a distance-measuring tool which captures an image by an electronic device and displays the distance to the object by urging a touch operation to be executed on the touchscreen display on which an image is displayed.

Moreover, if the distance to the object is acquirable per pixel, the length of each part of the object can also be calculated by using the distances. Therefore, for example, a measurement tool capable of capturing a piece of furniture and the like exhibited in a store and measuring the size of the piece of furniture can be implemented as a stand-alone type electronic device. As explained above, the reliability of distance depends on the edge direction or the object image, more specifically, the edge inclination direction of the pixel which is a processing target and the direction of the boundary between the first filter area and the second filter area of the filter 10. Thus, a GUI may be provided, which, if the reliability of distance is less than a threshold value, indicates the angle of rotation and displays a message to promote an image to be captured by rotating the electronic device on a display and the like so as to calculate a more exact distance as shown in, for example, FIG. 27. Alternately, the display may present the current direction of the electronic device by a rod-shaped figure such as a needle and an arrow, present the direction in which an exact distance can easily be calculated by a rod-shaped figure such as a needle and an arrow, or present the angle of rotation or the direction of rotation by an arrow.

According to the embodiments, as explained above, the reliability of distance to the object obtained from the image can be output and controlled by using the curvature of the correlation function.

Other embodiments will be explained hereinafter with reference to the accompanying drawings. The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

### Second Embodiment

As explained above, a distance from an image captured by an imaging apparatus which is a monocular camera equipped with a color aperture to an object is calculated. The color aperture is constituted by arranging a color filter including at least two color filter areas at an aperture of the imaging apparatus. An image sensor forms an image, based on light rays transmitted through the color aperture. In the example illustrated in FIG. 2, first and second filter areas have a semicircular shape formed by dividing a circular filter in a lateral (horizontal) direction by a vertical straight line passing through an optical center.

For example, the first filter area 11 is a yellow (Y) filter area, and the second filter area 12 is a cyan (C) filter area. The light rays of the wavelength band corresponding to a green (G) image is transmitted through the first and second filter areas 11 and 12, but the light rays of the wavelength band corresponding to a red (R) image is transmitted through the first filter area 11 alone and the light rays of the wavelength band corresponding to a blue (B) image is transmitted through the second filter area 12 alone. The blur of the R image and the B image is deviated toward the right or left side in accordance with whether the object is located at the front or back of the focal distance.

The difference in blur shape among the R, G, and B images changed by the color aperture corresponds to the distance in a one-on-one relationship. For this reason, convolution kernels which correct the blur shapes of the R and B images changed by the color aperture to the blur shape of the G image are prepared in each distance. Then, the convolution kernel in an assumed distance is applied for the R image and/or the B image, and the distance is determined based on the correlation between the corrected R/G image and the G image.

As shown in FIG. 8, a convolution kernel is distributed near a horizontal straight line which intersects a vertical straight line indicative of a dividing direction to divide the filter area into the first and second filter areas. Correction of the R and/or B image with such a convolution kernel is performed by a convolution of the R and/or B image and the convolution kernel in a horizontal direction. The result of the convolution is the same in any assumed distance at the horizontal edge (a contrast gradient direction is vertical) perpendicular to the filter area dividing direction of the color filter, and the distance may be unable to be determined. Therefore, an imaging apparatus of the second embodiment is configured to be installed such that the filter area dividing direction of the color filter is not perpendicular to the edge direction included in an object, i.e., the filter area dividing direction does not match the contrast gradient direction of the object.

### Example of Installation of Imaging Device

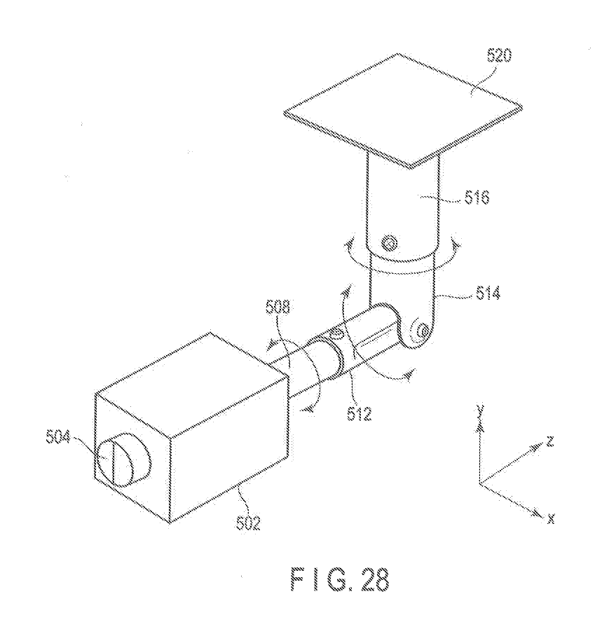

FIG. 28 shows an installation example of the imaging apparatus according to the second embodiment. The imaging apparatus of the second embodiment is applicable to many systems, for example, a monitoring system. FIG. 28 shows an example of attaching an imaging apparatus 502 equipped with a color aperture 504 to a room ceiling by an attachment instrument capable of tilt/pan/roll. Since tilt/pan is not directly related to the embodiment, these functions can be omitted. Furthermore, the roll function can also be omitted as explained later. As shown in FIG. 2, the X-axis and the Y-axis are axes in the plane of the color filter. The Z-axis is an axis of the optical axis direction of the imaging apparatus 502.

A tip of a cylindrical arm 508 is fixed to a center of a rear end of the imaging apparatus 502. An axis of the arm 508 matches the optical axis of the imaging apparatus 502. A rear end of the arm 508 is inserted into the tip of the arm 512 which is coaxial with the arm 508 and has a diameter larger than the arm 508. Therefore, the arm 508 (and the imaging apparatus 502) can be rolled clockwise or counterclockwise about an optical axis (also called a roll axis) in a state of being inserted into the arm 512.

A roll angle (i.e., an angle with reference to the vertical direction) of each of the clockwise rotation and the counterclockwise rotation does not need to be greater than or equal to 90 degrees but may be approximately 45 degrees. The rotation of the arm 508 is suppressed by a screw or the like and the roll angle is fixed. The imaging apparatus 502 can be installed such that the filter area dividing direction of the color filter does not cross the direction of the edge included in the object at right angles, i.e., the filter area dividing direction does not match the contrast gradient direction of the object, by adjusting the roll angle.

A rear end of the arm 512 is axially supported by a lower end of a vertical arm 514. This axis is called a silt axis. For this reason, the arm 512 (and the arm 508 and the imaging apparatus 502) can be tilted in the longitudinal direction. The rotation of the arm 512 is suppressed by a screw or the like and the tilt angle is fixed.

An upper end of the arm 514 is inserted into a lower end of an arm 516 which is coaxial with the arm 514 and has a diameter larger than the arm 514. For this reason, the arm 514 (and the arms 512 and 508, and the imaging apparatus 502) can be panned horizontally in a state of being inserted into the arm 516. The rotation of the arm 514 is suppressed by a screw or the like and a pan angle is fixed. An upper end of the arm 516 is integrated with an attachment plate 520 which is attached to a ceiling of a room.

The tilt angle and the pan angle may be fixed to specific angles before the imaging apparatus 502 is installed or may be adjusted by moving the arms 512 and 514 anon that a desired field of view can be captured after the installment.

FIG. 28 shows an example of an attachment instrument attached to a ceiling of a room, but the attachment instrument can also be attached to a room wall or a telephone pole, a street light and the like beside a street if the arm 516 is bent horizontally or a horizontal arm is further connected to the arm 516.

### Rotation of Imaging Device

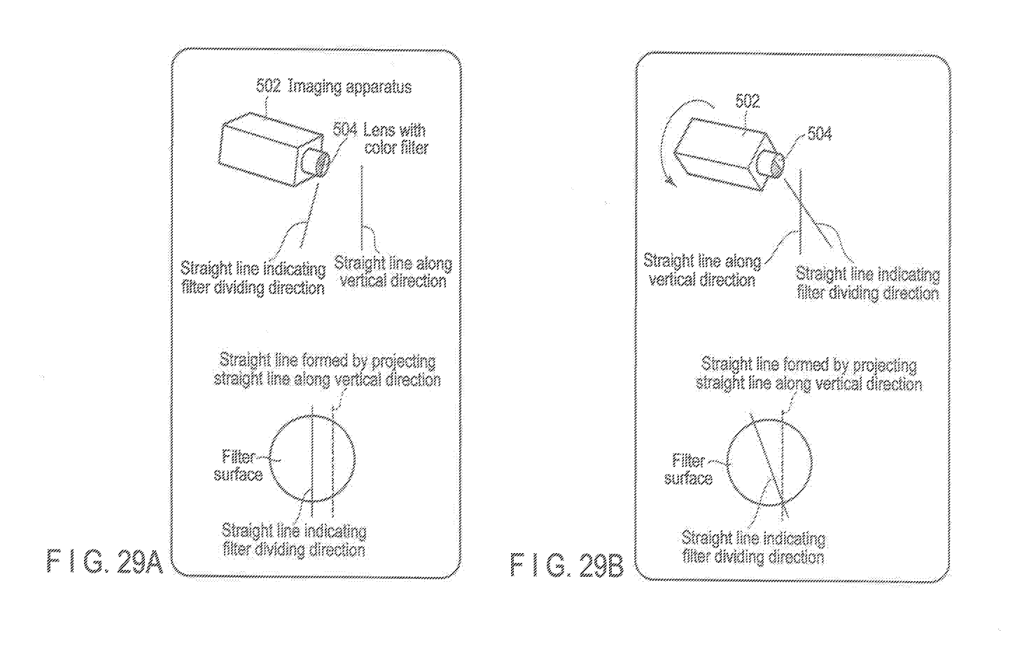

FIGS. 29A and 29B show an example of rotation of the imaging apparatus 502 according to the second embodiment. The filter dividing direction of the color filter is assumed to be a vertical direction and the edge at which the distance may not be calculated is assumed to a horizontal edge. Therefore, a straight line indicative of the vertical direction is assumed.

If the roll angle of the imaging apparatus 502 is zero degrees, i.e., the longitudinal direction of an image captured by the imaging apparatus 502 matches the vertical direction, a straight line obtained by projecting the straight line indicative of the vertical direction on the filter surface becomes parallel to the straight line indicative of the filter dividing direction as shown in FIG. 29A. In this state, the distance of the horizontal edge perpendicular to the straight line indicative of the filter dividing direction may not be calculated.

If the imaging apparatus 502 (arm 508) is rolled about the optical axis such that the longitudinal direction of the image captured by the imaging apparatus 502 does not match the vertical direction, the straight line obtained by projecting the straight line indicative of the vertical direction on the filter surface can be made nonparallel to the straight line indicative of the filter dividing direction as shown in FIG. 29B. Thus, the horizontal edge included in the object does not become perpendicular to the filter dividing direction, and the distance of the horizontal edge can be calculated.

In this case, the roll angle may be greater than zero degrees. If the roll angle is 90 degrees, the distance of the edge in the vertical direction may not be calculated. The roll angle may be approximately 45 degrees. Since the distance of the edge in one direction is not calculated even if the roll angle is changed, the distance of which edge can be calculated and the distance of which edge cannot be calculated depend on the user's thought.

After the image is captured and the distance is calculated after the installment, the user can also determine an appropriate roll angle by trial and error while considering the calculated distance and adjusting the roll angle. The roll angle may be determined based on an index such as the reliability as shown in FIGS. 15 and 16 after the installment. Alternatively if various edge directions included in the object are preliminarily known, an appropriate roll angle may be preliminarily obtained such that none of the edge directions is perpendicular to the filter dividing direction, and then the imaging apparatus may be installed after fixed at the angle.

Furthermore, when an appropriate roll angle is preliminarily determined from the directions of the known edges included in the object, the roll rotation mechanism shown in FIG. 28 is not indispensable if the imaging apparatus can be attached to the ceiling or the like in a state of being rotated about the optical axis. However, if the imaging apparatus is equipped. with the roll rotation mechanism, the imaging apparatus can easily cope with a case where the direction of the edge included in the object changes. If the imaging apparatus is not equipped with the roll rotation mechanism, the imaging apparatus may be installed again in a case where the direction of the edge included in the object changes.

The roll rotation mechanism is not limited to the example shown in FIG. 28. In FIG. 28, the roll rotation axis matches the optical axis of the imaging apparatus 502, but the imaging apparatus may be installed so as to be rotated about an axis other than the optical axis. For example, in FIG. 28, the imaging apparatus 502 is not attached to the tip of the arm 508, but a holder on which the imaging apparatus 502 is placed may be attached to the upper surface of the arm 508. In this case, if the arm 508 is rotated, a captured image is inclined about the axis of the arm 508 outside the screen. In the case of FIG. 28, if the arm 508 is rotated, a captured image is inclined about the optical axis in the screen.

### System Block Diagram

FIG. 30 is a block diagram showing an example of the imaging apparatus 502 according to the second embodiment. The second embodiment includes an imaging device (often called a camera) 505 and an image processor. The light rays from the object (collectively illustrated by an arrow of dashed line) are made incident on the image sensor 542 through an imaging lens 538 formed of a plurality of lenses (one lens illustrated for convenience). The image sensor 542 photoelectrically converts the incident light rays and outputs an image signal (a moving image or a still image), and any sensors such as an image sensor of charge coupled device (CCD) type, an image sensor of complementary metal oxide semiconductor (CMOS) type and the like can be used as the image sensor. At least one lens in the imaging lens 538 is movable along the optical axis to adjust the focus.

A color filter 536 is formed at the aperture (principal point or its vicinity) of the imaging lens 538. The imaging lens 538 to which the color filter 536 is added is also called the lens 504 with color aperture. The imaging device 505 is formed of the imaging lens 438, the image sensor 542, and the like. The example of arranging the color filter on an entire surface of the aperture of the imaging lens 538 is explained but the color filter may not be arranged on the entire surface of the aperture. For example, the aperture may be constituted by a color filter area and an area in which the color filter is not provided.

The image processor is formed of a central processing unit (CPU) 544, a nonvolatile storage 546 such as a flash memory or a hard disk drive, a volatile memory 548 such as a Random Access Memory (RAM), a communication interface 550, a display 556, a memory card slot 552 and the like. The image sensor 542, the CPU 544, the nonvolatile storage 546, the volatile memory 548, the communication interface 550, the display 556, the memory card slot 552 and the like are interconnected by a bus 554.

The imaging device 505 and the image processor may be formed separately or integrally. If the imaging device 505 and the image processor are formed integrally, they may be implemented as an electronic device equipped with a camera, such as a smartphone, a tablet and the like. If the imaging device 505 and the image processor are formed separately, a signal output from the imaging device 505 implemented as a single-lens reflex camera or the like may be input to the image processor implemented as a personal computer or the like. Several parts of the image processor shown in FIG. 30 may be formed inside the imaging device 505.

The CPU 544 controls the total operations of the overall system. For example, the CPU 544 executes a capture control program, a distance calculation program, a display control program, and the like stored in the nonvolatile storage 546, and implements the functional blocks for capture control, distance calculation, display control, and the like. The CPU 544 thereby controls not only the image sensor 542 of the imaging device 505 but the display 556 and the like of the image processor.

In addition, the functional blocks for capture control, distance calculation, display control, and the like may be implemented by not the CPU 544 but exclusive hardware. For example, the distance calculation program obtains the distance to the object for every pixel of a captured image, based on the above-explained principle.

The nonvolatile storage 546 is formed of a hard disk drive, a flash memory, and the like. The display 556 is formed of a liquid crystal display, a touch panel, or the like. The display 556 executes the color display of the captured image, and displays the distance information calculated for each pixel, in a specific form, for example, as a distance image (also called a depth map) in which the captured image is colored in accordance with the distance. The distance information may not be displayed as the depth map, but displayed in a table form such as a correspondence table of the distance and the position, and the like, as shown in FIG. 15.

For example, the volatile memory 548 formed of a Synchronous Dynamic Random Access Memory (SDRAM) or the like stores various types of data used for the programs and processing related with control of the overall system.

The communication I/F 550 is an interface configured to control the communications with an external device and the input of various instructions made by the user who uses a keyboard, an operation button, and the like. The captured image and the distance information may not only be displayed on the display 556, but may be transmitted to external device via the communication I/F 550 and used by the external device having operations controlled based on the distance information.

Examples of the external device include a traveling assistance system for a vehicle, a drone, and the like, a monitoring system which monitors intrusion of a suspicious person, and the like. Calculation of the distance information may be shared by a plurality of devices such that the image processor executes a part of the processing for calculating the distance from the image signals and the external devices such as a host execute the remaining parts of the processing.

A portable storage medium such as a Secure Digital (SD) memory card, an SD High-Capacity (SDHC) memory card, and the like can be inserted in the memory card slot 552. The captured image and the distance information may be stored in the portable storage medium, the information in the portable storage medium may be read by the another device, and the captured image and the distance information may be therefore used by the other device.

Alternatively, the image signal captured by the another imaging device may be input to the image processor of the present system via the portable storage medium in the memory card slot 552, and the distance may be calculated based on the image signal. Furthermore, the image signal captured by the other imaging device may be input to the image processor of the present system via the communication I/F 550.

FIG. 31 is a functional block diagram for the distance calculation and display control executed by the CPU 544. The output of the image sensor 542 is supplied to the captured image input device 562, and a captured image of the object is obtained. The captured image is supplied to an inclination corrector 566 and a depth map input device 564. The depth map input device 564 obtains the distance to the object for each pixel of the captured image, based on a distance calculation program, and obtains the captured image colored in accordance with the distance as a depth map. The depth map is supplied to an inclination corrector 568.

The inclination correctors 566 and 568 rotate the image at an angle of rotation supplied from a rotation angle/rotational center input device 570 about the rotational center supplied from the rotation angle/rotational center input device 570. The rotation angle/rotational center input device 570 obtains the rotational censer and the rotation angle (positive in a clockwise direction and negative in a counterclockwise direction) of the imaging apparatus 502.

The inclination correctors 566 and 568 rotate the image in a direction opposite to the direction indicated by the rotation angle. The rotation angle/rotational center input device 570 can acquire the rotational center and the rotation angle by tracking characteristic points in a plurality of sequential captured images. However, a value preliminarily measured by the user may be input and set in the rotation angle/rotational center input device 570. The images rotated in the inclination correctors 566 and 568 are displayed on the display 556.

### Correction of Inclination of Image

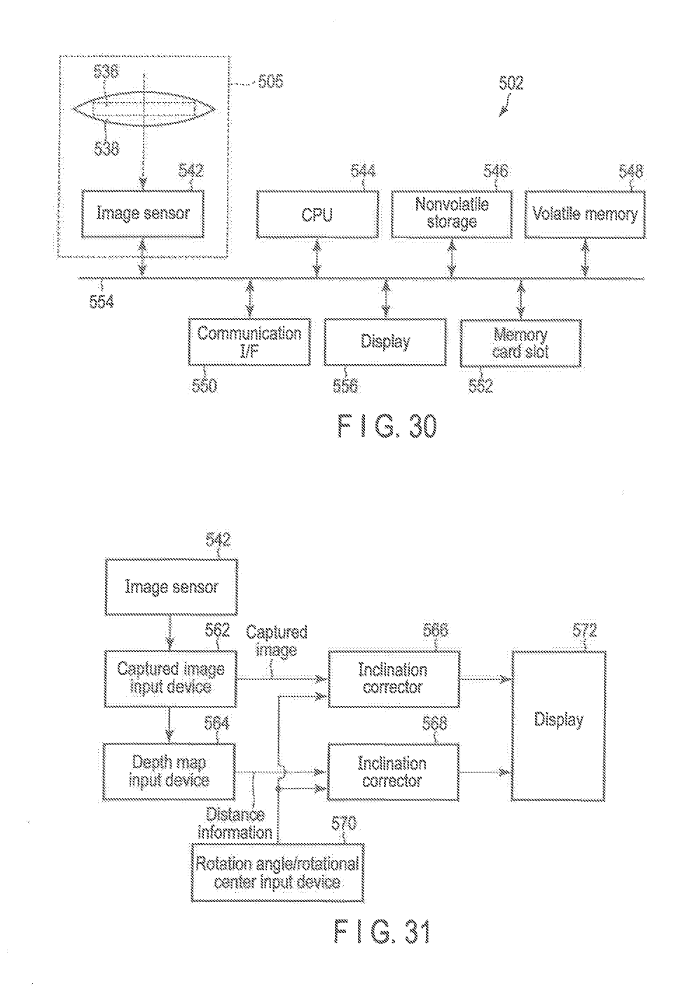

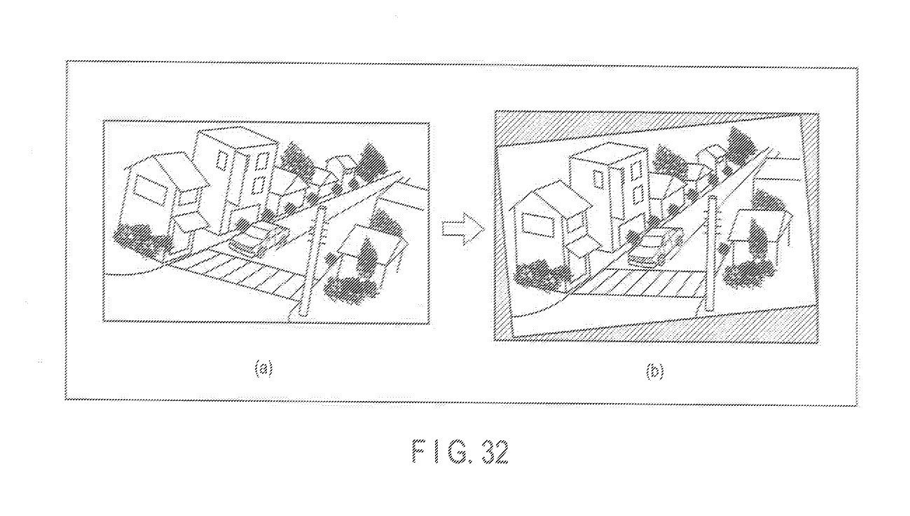

An example of inclination correction will be explained with reference to FIG. 32. After the imaging apparatus 502 is installed on the ceiling or the like in a state in which the roll angle is set at zero degrees, the depth image is displayed based on the calculated distance. If the user observes the depth map and determines that the distance of horizontal edge is incorrect, the user rotates the imaging apparatus 502 about the optical axis. If the imaging apparatus 502 is rotated clockwise about the optical axis, the captured image input by the captured image input device 562 becomes a captured image in which the horizontal line is rotated clockwise, as shown in a left image (a) of FIG. 32. In other words, the straight line indicative of the filter dividing direction is the vertical line in the image, but the straight line in which the vertical direction is projected on the filter surface is inclined to a clockwise rotation from the vertical direction in the image.

The image may be sufficient as it is, but includes unnatural feeling for image observation. The inclination corrector 566 rotates the captured image counterclockwise, and generates a corrected image in which the horizontal line matches the horizontal direction of the image as shown in a right image (b) of FIG. 32. Inclination of the depth map is also corrected similarly. The inclination correction does not need to be necessarily executed. Correction of the inclination is often preferable to display the image, but the inclination correction is unnecessary in many cases when the depth map is not displayed by merely using the calculated distance.

### Example of Color Filter

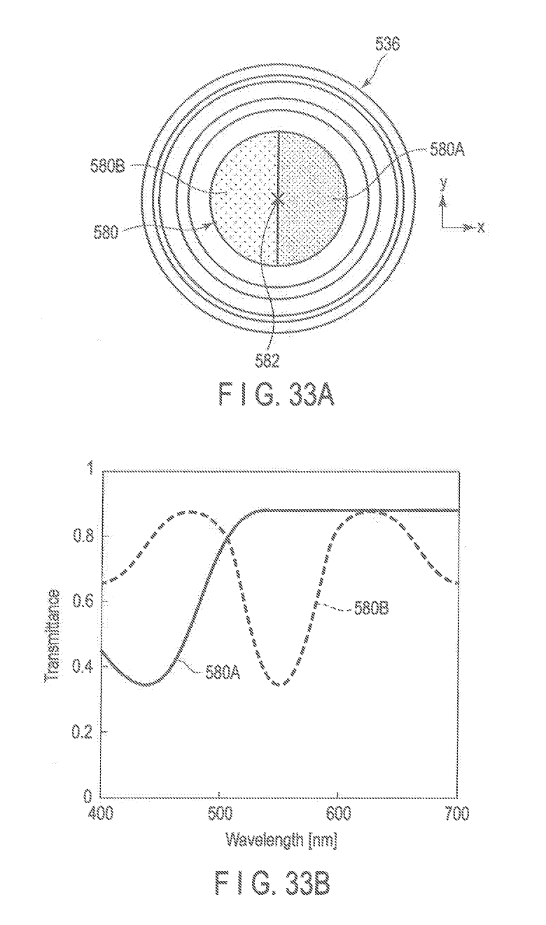

FIG. 33A shows an example of the color filter 536 of the imaging apparatus according to the second embodiment. A filter area 580 in the center area of the color filter 536 is formed of, for example, color filter areas of two colors, i.e., a first filter area 580A and a second filter area 580B. The center of the filter area 580 matches an optical center 582 of the imaging device 502. Each of the first filter area 580A and the second filter area 580B has a non-point-symmetric shape about the optical center 582. The first filter area 580A and the second filter area 580B do not overlap each other and the entire filter area 580 is formed of the first filter area 580A and the second filter area 580B. Each of the first filter area 580A and the second filter area 580B has a semicircular shape formed by dividing the circular filter area 580 by a line passing through the optical center 582.

A straight line which is perpendicular to a line segment connecting centers of gravities of the first filter area 580A and the second filter area 580B at a middle point of the line segment is defined as a straight line indicative of the filter dividing direction. If the first filter area 580A and the second filter area 580B are formed in the same size and the same shape, the straight line indicative of the filter dividing direction is a straight line which actually divides the filter area 580 shown in FIG. 33A (i.e., a straight line including diameters of two semicircles in contact with each other).

The first filter area 580A and the second filter area 580B are color filters through which light rays of specific wavelength bands different from each other are transmitted. The light rays of the color common to the filter areas 580A and 580B are transmitted through the filter area 580. To increase a quantity of the transmitted light rays, the filter surface of the filter area 580 may be set to be parallel to the imaging surface of the image sensor 542.

The light rays of a first combination of colors, of the colors of the light rays received by the image sensor 542, are transmitted through the first filter area 580A. The first combination is an arbitrary combination. For example, the first filter area 580A is a yellow (Y) filter through which the light rays of a wavelength band corresponding to the R image and the light rays of a wavelength band corresponding to the G image are transmitted as shown in FIG. 33B.

The light rays of a second combination of colors different from the first combination, of the colors of the light rays received by the image sensor 542, are transmitted through the second filter area 580B. For example, the second filter area 580B is a magenta (M) filter through which the light rays of a wavelength band corresponding to the B image and the light rays of a wavelength band corresponding to the R image are transmitted as shown in FIG. 33B.

The color of the light rays transmitted commonly through the Y and M filters is R. In general, it is well known that since a complementary color filter of C, M, and Y has a higher sensitivity than a primary color filter of R, G, and B, a more quantity of light rays is transmitted through the filter even if the transmittance in the same wavelength band is the same.

The combination of the first filter area 580A and the second filter area 580B is not limited to the above combination, but the first filter area 580A may be a Y filter through which the light rays of the wavelength band corresponding to the R image and the light rays of the wavelength band corresponding to the G image are transmitted and the second filter area 580B may be a cyan (C) filter through which the light rays of the wavelength band corresponding to the B image and the light rays of the wavelength band corresponding to the G image are transmitted.

The first filter area 580A may be an M filter through which the light rays of the wavelength band corresponding to the R image and the light rays of the wavelength band corresponding to the B image are transmitted and the second filter area 580B may be the C filter through which the light rays of the wavelength band corresponding to the B image and the light rays of the wavelength band corresponding to the G image are transmitted.

The first filter area 580A may be any one of C, M, and Y filters and the second filter area 580B may be a transparent filter through which the light rays of all the colors are transmitted. Furthermore, the first filter area 580A is located on the right side and the second filter area 580B is located on the left side in FIG. 33 but, oppositely, the first filter area 580A may be located on the left side and the second filter area 580B may be located on the right side.

Each of the first filter area 580A and the second filter area 580B may be a filter which varies a transmittance of an arbitrary wavelength band, a polarizing filter (polarizer) which passes polarized light in an arbitrary polarizing direction, or a microlens which varies a condensing power of an arbitrary wavelength band.

For example, the filter which varies the transmittance of an arbitrary wavelength band may be a primary color filter of R, G, and B, a complementary color filter of C, M, and Y, a color correction filter (CC-RGB/CMY) an infrared/ultraviolet blocking filter, an ND (Neutral Density) filter, or a shielding plate. If the first filter area 580A and the second filter area 580B are formed of microlenses, the distribution of light condensation is deviated by the imaging lens 538 and the blur function is thereby varied.

FIG. 33B shows an example of the transmittance characteristics of the first filter area 580A and the second filter area 580B. A transmittance characteristic 586A of the first filter area 580A which is a yellow filter indicates that the light rays of the wavelength bands corresponding to the R image and the G image are transmitted through the filter area at a high transmittance while the light rays of the wavelength band corresponding to the B image are hardly transmitted. A transmittance characteristic 586B of the second filter area 580B which is a magenta filter indicates that the light rays of the wavelength band corresponding to the B image and the R image are transmitted through the filter area at a high transmittance while the light rays of the wavelength band corresponding to the G image are hardly transmitted.

Therefore, the light rays of the wavelength band corresponding to the R image are transmitted through both of the first filter area 580A and the second filter area 580B. The light rays of the wavelength band corresponding to the G image are transmitted through the first filter area 580A alone and the light rays of the wavelength band corresponding to the B image are transmitted through the second filter area 580B alone. The shapes of the blur on the G and B images are changed in accordance with the distance to the object.

Since each of the filter areas is asymmetric about the optical center, the shapes of the blur on the R image and the B image are varied in accordance with whether the object is located in front of or behind the focal length. In other words, the shapes of the blur on the R image and B image are deviated. Therefore, a convolution kernel which corrects the shapes of the blur of the G image and the B image to the shape of the blur of the R image is prepared for each distance, the convolution kernel in the assumed distance is applied to the G image and/or B image to correct the image, and the distance can be determined based an correlation between the corrected image and the R image.

The positions, shapes and sizes of the first filter area 580A and the second filter area 580B are arbitrarily set, but the manner of blurring the G image and the B image can be controlled in accordance with the shapes of the first filter area 580A and the second filter area 580B. If the shape of each filter area changes, manner of blurring the G image and the B image can be controlled since the Point Spread Function (PSF) which is the blur function can be controlled arbitrarily.

The example of matching the blur functions of the G image and the B image is explained in the above descriptions, but the unnaturalness for constituting the display image can be controlled if blurring of the images is controlled to be symmetrical. In addition, if the blurring of the G image and the blurring of the B image are set to be the same, matching of the G image and the B image becomes easy and the depth estimation accuracy can be improved.

### Modified Example of Color Filter

The filter area 580 shown in FIG. 33A is divided such that all the areas are constituted by the first filter area 580A and the second filter area 580B. An example of dividing the filter area into first, second, and third filter areas will be explained as a modified example.

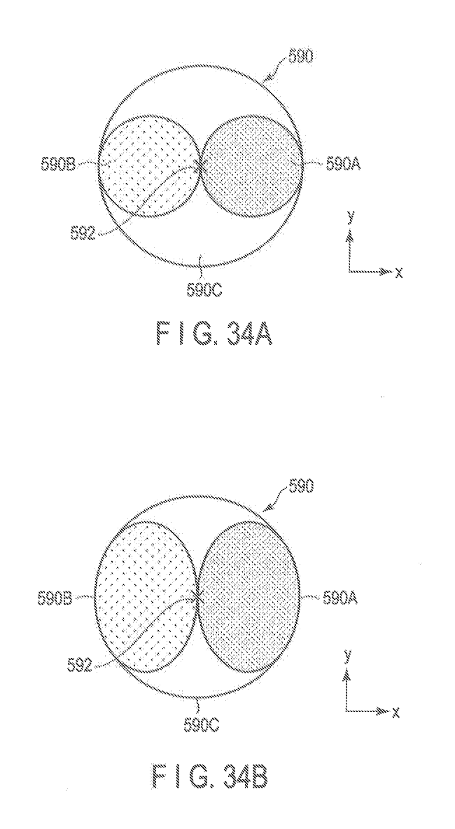

FIGS. 34A and 34B show a first modified example of the color filter of the imaging apparatus according to the second embodiment. As shown in FIGS. 34A and 34B, a filter area 590 is formed of a first filter area 590A, a second filter area 590B, and a third filter area 590c. Similarly to the example shown in FIG. 33A, light rays of different combinations of colors are transmitted through the first filter area 590A and the second filter area 590B, and the light rays of a common color which are transmitted through the first filter area 590A and the second filter area 590B, are transmitted through the third filter area 590C.

If the first and second filter areas 590A and 590B are Y and M or M and Y filters, the third filter area 590C is the R filter. If the first and second filter areas 590A and 590B are Y and C or C and Y filters, the third filter area 590C is the G filter. If the first and second filter areas 590A and 590B are C and M or M and C filters, the third filter area 590C is the B filter. The third filter area 590C may be a transparent filter through which the light rays of all the colors of R, G, and B are transmitted.

In FIG. 34A, the first and second filter areas 590A and 590B are located on the right and left sides of a straight line which passes through an optical center 592 and extends along the Y-axis, and their shapes are circles which are in contact with each other at the optical center 592. The third filter area 590C is an area other than the first and second filter areas 590A and 590B. In FIG. 34B, the first and second filter areas 590A and 590B are located on the right and left sides of the straight line which passes through the optical center 592 and extends along the Y-axis, and their shapes are ellipses which are in contact with each other at the optical center 592.

In FIGS. 34A and 34B, the first and second filter areas 590A and 590B are areas of the same size arranged to have a linear symmetry with respect to the straight line which passes through the optical center 592 and extends along the Y-axis, but two areas 590A and 590B of different sizes may be arranged to have a nonlinear symmetry. The shape of the first and second filter areas 590A and 590B is not limited to a circle and an ellipse, but may be triangle, a rectangle, and a polygon.

The straight line which is perpendicular to a line segment connecting centers of gravities of the first and second filter areas 590A and 590B at a middle point of the line segment is a straight line which passes through the optical center 592 and extends along the Y-axis if the first and second filter areas 590A and 590B have a linear symmetry with respect to the Y-axis.

The first and second filter areas 590A and 590B are in contact with each other at the optical center 592 in the first modified example shown in FIG. 34A, and a second modified example in which the first and second filter areas are not in contact with each other will be explained below.

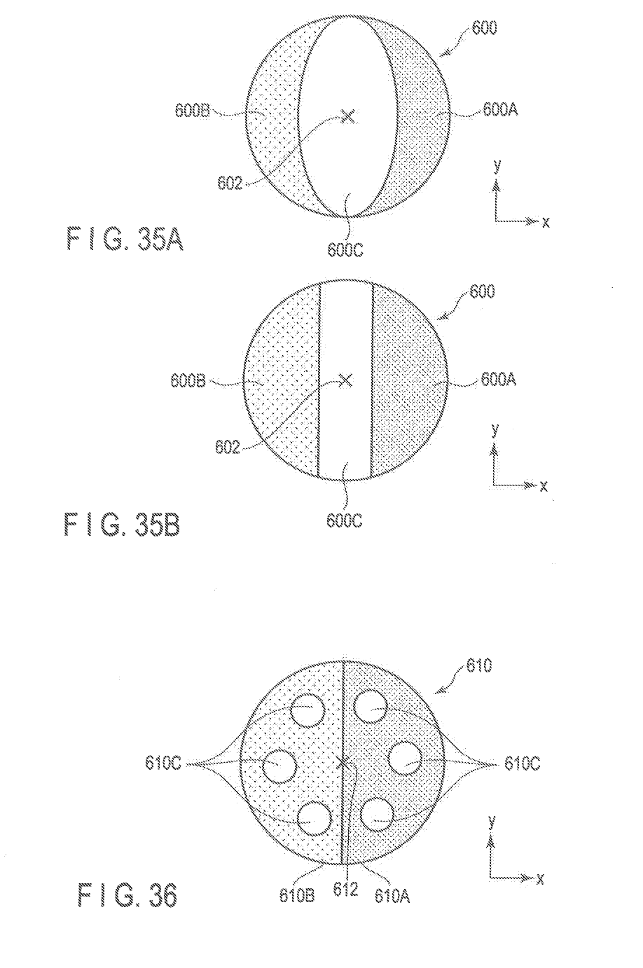

FIGS. 35A and 35B show a second modified example of the color filter of the imaging apparatus according to the second embodiment. As shown in FIGS. 35A and 35B, a filter area 600 is formed of a first filter area 600A, a second filter area 600B, and a third filter area 600C. Similarly to the examples shown in FIG. 33 and FIGS. 34A and 34B, light rays of different combinations of colors are transmitted through the first filter area 600A and the second filter area 600B, and the light rays of a common color which are transmitted through the first filter area 600A and the second filter area 600B, are transmitted through the third filter area 600C. The example of the colors of the first and second filter areas 600A and 600B is the same as the first modified example.

In FIG. 35A, the shapes of the first and second filter areas 600A and 600B are crescents located on the right and left sides of a straight line which passes through an optical center 602 and extends along the Y-axis. The shape of the third filter area 600C, other than the first and second filter areas 600A and 600B, is an ellipse.

In FIG. 35B, the circular filter area 600 is divided into three parts by two straight lines extending along the Y-axis, and the central part is the third filter area 600C, and both sides of the third filter area 600C are the first filter area 600A and the second filter area 600B.

The circular filter area 600 may be divided into three parts by not two straight lines, but two wave lines. Two division lines may not be parallel to each other. Furthermore, the filter area may not be divided into three equal parts, and the sizes of three divisional areas may be arbitrarily set.

The straight line which is perpendicular to a line segment connecting centers of gravities of the first and second filter areas 600A and 600B at a middle point of the line segment is a straight line which passes through the optical center 602 and extends along the Y-axis if the first and second filter areas 600A and 600B have a linear symmetry with respect to the Y-axis.

FIG. 36 shows a third modified example of the color filter of the imaging apparatus according to the second embodiment. A filter area 610 includes first and second filter areas 610A and 610B formed in a semicircular shape, similarly to the filter area 580 shown in FIG. 33A. A plurality of third filter areas 610C are provided in the first and second filter areas 610A and 610B. The shape, number, and arrangement of the third filter areas 610C are arbitrarily set.

The straight line which is perpendicular to a line segment connecting centers of gravities of the first and second filter areas 610A and 610B at a middle point of the line segment is a straight line which passes through the optical center 602 and extends along the Y-axis if the first and second filter areas 600A and 600B have a linear symmetry with respect to the Y-axis and the third filter areas 610C have a linear symmetry with respect to the Y-axis.

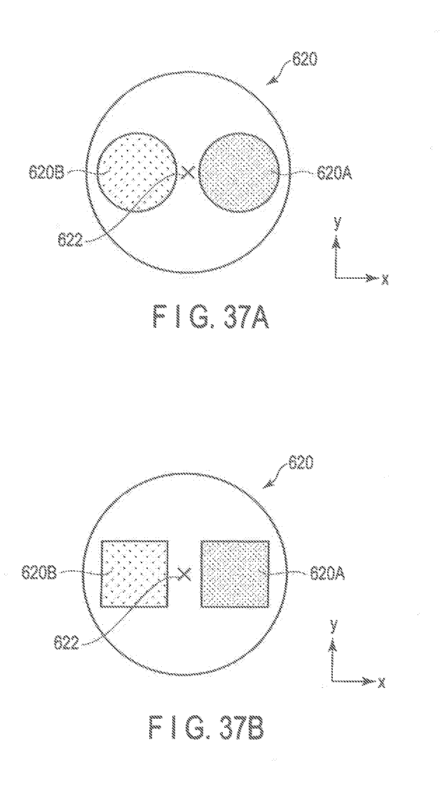

FIGS. 37A and 37B show a fourth modified example of the color filter of the imaging apparatus according to the second embodiment. In the fourth modified example, the first and second filter areas of the second embodiment shown in FIGS. 34A and 34B are not in contact with each other and remote from each other.

In FIG. 37A, first and second filter areas 620A and 620B are located remote from each other, on the right and left sides of a straight line which passes through an optical center 622 and extends along the Y-axis, and their shape is a circle.

In FIG. 37B, the first and second filter areas 620A and 620B are located remote from each other, on the right and left sides of a straight line which passes through the optical center 622 and extends along the Y-axis, and their shape is a square. The shape of the first and second filter areas 620A and 620B is not limited to a circle or a square but may be a triangle, a rectangle or a polygon, and a plurality of first and second filter areas 620A and 620B may be provided, and the first and second filter areas 620A and 620B may be provided to have an asymmetry in the lateral (horizontal) direction.

The straight line which is perpendicular to a line segment connecting center of gravities of the first and second filter areas 620A and 620B at a middle point of the line segment is a straight line which passes through the optical center 622 and extends along the Y-axis if the first and second filter areas 620A and 620B have a linear symmetry with respect to the Y-axis.

Consequently, the filter areas of the color filter may be formed of the first and second filter areas which transmit the light rays of the common color and which have different light transmitting properties. The filter areas may be formed of the first and second filter areas which transmit the light rays of the common color and which have different light transmitting properties and the third filter area which transmits the light rays of the common color.

The filter areas may be formed of the first and second filter areas which transmit the light rays of the common color and which have different light transmitting properties and the third filter area which transmits the light rays of all the colors. For example, the filter areas may be formed of an arbitrary number of and arbitrary types of filter areas besides the first and second filter areas. The arbitrary number of and arbitrary types of filter areas may be selected from the R filter, G filter, B filter, Y filter, C filter, M filter and transparent filter.

According to the second embodiment, the direction of the edge at which the distance to the object may not be calculated due to being perpendicular to the filter area dividing direction can be changed by installing the imaging apparatus 502 in a state in which the imaging apparatus 502 can be rotated about the optical axis and the filter area dividing direction of the color filter is rotated. For this reason, the edge at which distance may not be calculated can be set to an edge which is not or is hardly included in the object. For example, a condition that the distance on the edge in the horizontal direction may not be calculated can be prevented.

The attachment instrument may include an electric rotation mechanism for rotating the imaging apparatus 502 in the roll direction as explained with reference to FIG. 18 and FIG. 19, and the imaging apparatus 502 may be automatically rotated in accordance with the index on the reliability of the calculated distance.

### Third Embodiment

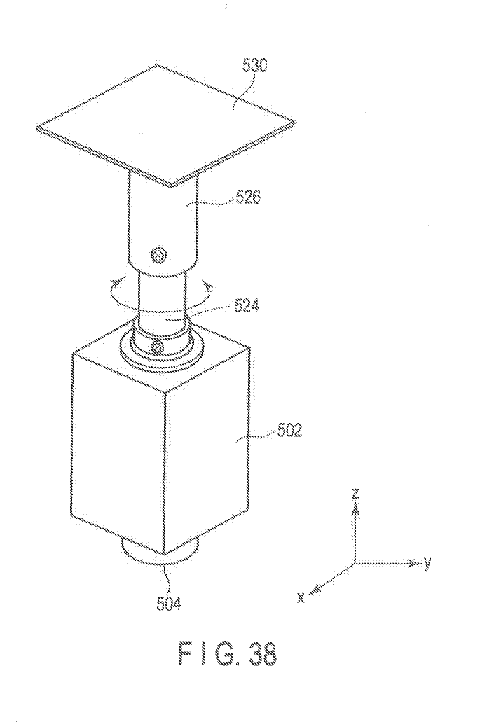

FIG. 38 shows an example of installation of an imaging apparatus according to the third embodiment. The third embodiment is also applicable to many systems, for example, a monitoring system. The second embodiment captures an image of the obliquely lower object seen from the ceiling, wall, column or the like. The third embodiment captures an image of a just lower object seen from the ceiling. A tip of a cylindrical arm 524 is fixed to the center of a rear end of the imaging apparatus 502. An axis of the arm 524 matches an optical axis of the imaging apparatus 502. A rear end of the arm 524 is inserted into a tip of an arm 526 which is coaxial with the arm 524 and has a larger diameter than the arm 524. Therefore, the arm 524 (and the imaging apparatus 502) can be rolled clockwise and counterclockwise about an optical axis (also called a roll axis) in a state of being inserted into the arm 526. An upper end of the arm 526 is integrated with an attachment plate 530 which is attached to a ceiling of a room.

Similarly to the second embodiment, the roll angle needs only to be greater than zero degrees in both the clockwise direction and the counterclockwise direction. If the roll angle is 90 degrees, the distance of the edge in the vertical direction may not be calculated. The roll angle may be approximately 45 degrees. Since the distance of the edge in one direction is not calculated even if the roll angle is changed, the distance of which edge can be calculated and the distance of which edge cannot be calculated depend on the user's thought.

After the image is captured and the distance is calculated after the installment, the user can also determine an appropriate roll angle by trial and error while considering the calculated distance and adjusting the roll angle. The roll angle may be determined based on an index such as the reliability as shown in FIGS. 15 and 16 after the installment.

Alternatively, if various edge directions included in the object are preliminarily known, an appropriate roll angle may be preliminarily determined such that none of the edge directions is perpendicular to the filter dividing direction, i.e., the filter area dividing direction does not match the contrast gradient direction of the object, and then the imaging apparatus 502 may be installed after fixed at the angle.

Furthermore, when an appropriate roll angle is preliminarily determined from the directions of the known edges included in the object, the roll rotation mechanism shown in FIG. 38 is not indispensable if the imaging apparatus 502 can be attached to the ceiling or the like in a state of being rotated about the optical axis at attachment of the attachment plate 530 on the ceiling. However, if the imaging apparatus 502 is equipped with the roll rotation mechanism, the imaging apparatus 502 can easily cope with a case where the direction of the edge included in the object changes. If the imaging apparatus 502 is not equipped with the roll rotation mechanism, the imaging apparatus may be installed again in a case where the direction of the edge included in the object changes.

### Rotation of Imaging Device

FIGS. 39A and 39B show an example of rotation of the imaging apparatus according to the third embodiment. In the third embodiment, if the vertical direction is projected on a filter surface, the projected direction does not become a straight line but becomes a point since the optical axis of the imaging apparatus 502 extends in the vertical direction. For this reason, a definition of a condition that the distance may not be calculated is different from the definition of the second embodiment.

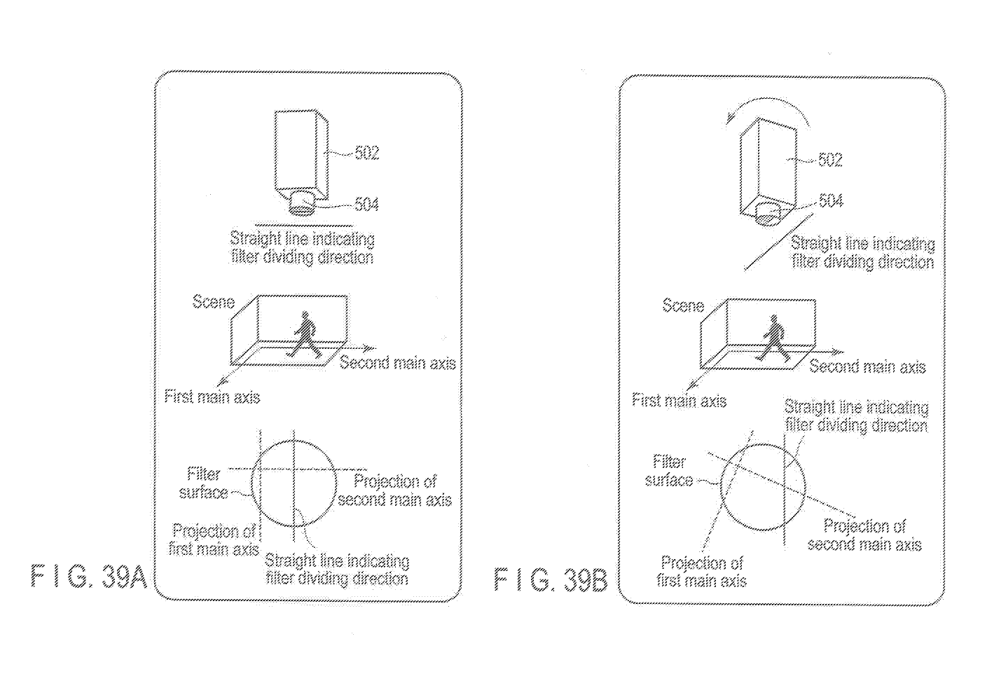

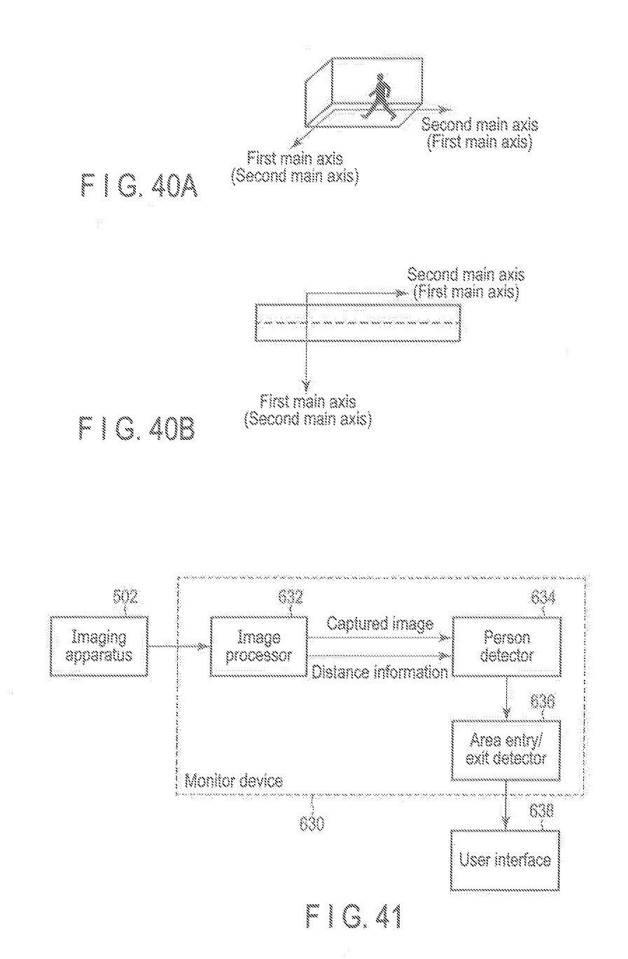

In the third embodiment, two axes (called main axes) intersecting in an object's scene are defined. The main axes are set based on the main structure of a scene. For example, as shown in FIG. 40A, a first main axis and a second main axis can be generally set along two sides of a rectangular floor surface, inside a room. In addition, when a person is moving, the first main axis and the second main axis may be set along a moving direction and a direction perpendicular to the moving direction. As shown in FIG. 40B, in a road, a passage, and the like, the first main axis and the second main axis can be set along a direction of extension of the road, passage, and the like and a direction perpendicular to the direction of extension. When a vehicle or a person is moving, the first main axis and the second main axis may be set along its moving direction and a direction perpendicular to the moving direction.

When the roll angle of the imaging apparatus 502 is zero degrees, a straight line in which the first main axis is projected to the filter surface or a straight line in which the second main axis is projected to the filter surface, and the straight line indicative of the filter dividing direction become parallel, as shown in FIG. 39A. In this state, the distance of the edge in the second main axis direction may not be calculated. As shown in FIG. 39B, the imaging apparatus 502 (arm 524) can be rolled about an optical axis, the straight line indicative of the filter dividing direction can become nonparallel to the straight line obtained by projecting the first main axis on the filter surface and the straight line obtained by projecting the second main axis on the filter surface, i.e., the straight line indicative of the filter dividing direction can become perpendicular to the straight line obtained by projecting the first main axis on the filter surface and the straight line obtained by projecting the second main axis on the filter surface.

Thus, the edges in the directions of the first main axis and the second main axis which are included in the object do not become perpendicular to the filter dividing direction, and the distance of the edges in the directions of the first main axis and the second main axis can be calculated. In this case, the roll angle may be greater than zero degrees and smaller than 90 degrees, for example, nearly 45 degrees.

In the third embodiment, too, the direction of the edge in which the distance to the object may not be calculated since the direction is perpendicular to the filter area dividing direction can be changed by rotating the imaging apparatus 502 about the optical axis and rotating the filter area dividing direction of the color filter, similarly to the second embodiment. For this reason, the edge at which distance may not be calculated can be set to an edge which is not or is hardly included in the object. For example, the situation that the distance concerning the edges in the first main axis direction and the second main axis direction inside the object may not be calculated can be prevented.

The display of the distance information is explained as an example of the mode of outputting the depth map in the above-described embodiments, but the outputting mode is not limited to this and may be display of a table of correspondence between the distance and the position. In addition to the distance to the object for each pixel, a maximum value, a minimum value, a central value, an average and the like of the distance information of the object in the whole screen may be output. Furthermore, it is possible to divide the depth map into small depth maps which are obtained by dividing the depth map in accordance with the distance in place of the depth map of the whole screen.

The following information can be obtained by processing the blur of the image signal of each pixel by using the distance information. An omni-focal image in which the image signals of all the pixels are a focusing status can be obtained. A refocus image in which a focusing state at the time of capturing is changed, i.e., an out-of-focus captured image is changed to a focused image and a focused captured image is changed to an out-of-focus image is obtained. It is possible to extract an object in an arbitrary distance and recognize the extracted object. Furthermore, the object's behavior can also be estimated by following the previous variation of the distance of the recognized object.

In the embodiments, the distance information is displayed such that the user can recognize the distance information on the image processor, but is not limited to this, and the distance information may be output to another device and used in the other device. According to the embodiments, the captured image and the distance information can be acquired by using not a stereo camera, but a monocular camera, and a small lightweight monocular camera can be applied in various fields.

### Application Example 1

### Monitoring System

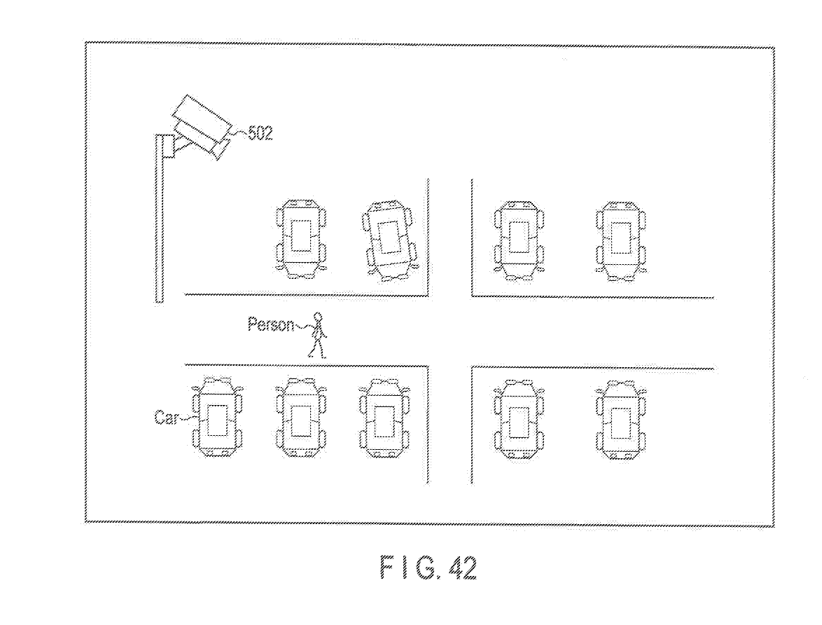

A monitoring system detects an entry of an object into a space which is captured by an imaging apparatus and issued an alarm, if necessary. FIG. 42 shows an example of a monitoring system. FIG. 42 shows a system for detecting a flow of persons or vehicles for time zones in a parking lot. A monitoring system is not limited to the monitoring system in the parking lot and may monitor various objects moving in a captured range, such as a shop or store, of the imaging apparatus 502.

FIG. 41 shows an exemplary block diagram of a monitoring system. The monitoring system includes the imaging apparatus 502, a monitor device 630, and a user interface 638. The monitor device 630 includes an image processor 632, a person detector 634, and an area entry/exit detector 636. The captured image input device 562 and the depth map input device 564 of FIG. 31 correspond to the image processor 632.

An output from the imaging apparatus 502 is supplied to the image processor 632. The captured image and the distance information output from the image processor 632 are supplied to the person detector 634. The person detector 634 detects a person or a moving object such as a car based on a change in the distance information and supplies the detection result to the area entry/exit detector 636.

The area entry/exit detector 636 determines whether the person or the moving object enters in or exits from a specific area with a specific distance range based on the detected distance to the person or the moving object. The area entry/exit detector 636 may analyze, for example, a flow of persons indicative of entry of a person in the specific distance range or exit of a person from the specific distance range or a flow of cars indicative of entry of a car in the specific distance range or exit of a car from the specific distance range. A storage such as a HDD (Hard Disk Drive) may be connected to the area entry/exit detector 636 and the result of analysis may be scored in the storage.

The person detector 634 and the area entry/exit detector 636 may be implemented by a CPU. The detection of the person or the moving object and the determination whether the person or the moving object enters in/exits from the specific area may be combined into one operation.

FIG. 42 shows a usage example of the monitoring system. The imaging apparatus 502 is installed in the parking lot. The flow of cars or persons in the parking lot can be monitored by using the output from the imaging apparatus 502. The specific area may be set in a part of a capturing range of the imaging apparatus 502.

When entry/exit of person or car is detected, the user interface 638 may issue an alarm. The alarm may include an alert text on the display and an alert sound from a speaker. The user interface 638 may also perform an input processing from a keyboard or a pointing device. If the user interface 638 includes the display and the pointing device, the user interface 638 may be a touch screen display.

The monitoring system may perform another action instead of issuing an alarm. For example, the camera captures a space in front of an automatic door and the door is opened when a person comes into the space.

### Application Example 2

### Automatic Door System

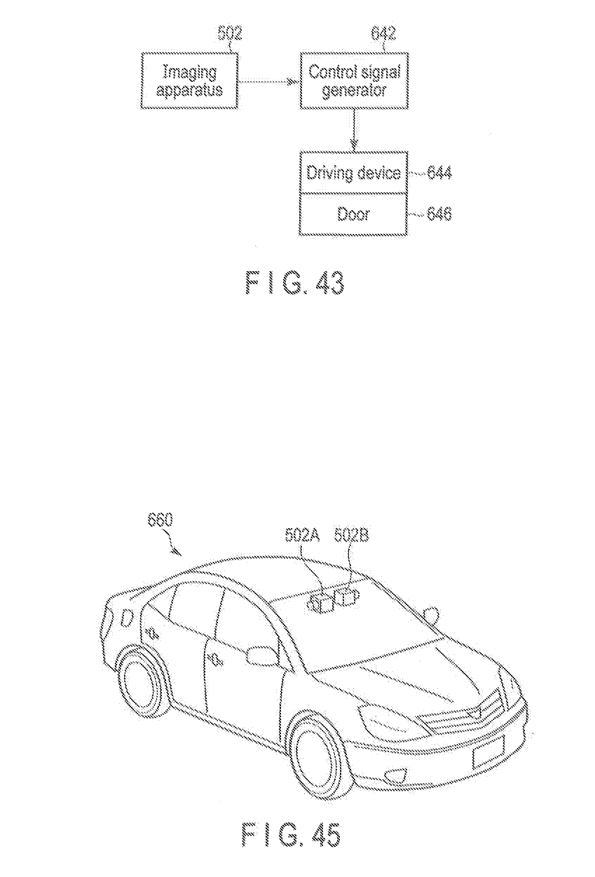

FIG. 43 shows an example of a functional block diagram of an automatic door system including the imaging apparatus 502. The automatic door system includes the imaging apparatus 502, a control signal generator 642, a driving device 644, and a door 646. The control signal generator 642 corresponds to the monitor device 630 of FIG. 41.

The control signal generator 642 includes functions of the captured image input device 562 and the depth map input device 564 of FIG. 31 and the person detector 634 and the area entry/exit detector 636 of FIG. 41. The control signal generator 642 determines whether the object is in front of or behind the reference plane having the reference distance, generates a control signal for opening/closing the door 646 based on the result of determination, and outputs the control signal to the driving device 644.

More specifically, the control signal generator 642 generates the control signal for opening the door 646 or keeping the door 646 in an opened state when it is determined that the object is in front of the reference plane. The control signal generator 642 generates the control signal for closing the door 646 or keeping the door 646 in a closed state when it is determined that the object is behind the reference plane.

The driving device 644 includes a motor, for example, and opens or closes the door 646 by transmitting the rotating force to the door 646. The driving device 644 sets the door 646 in an opened state or closed state based on the control signal generated by the control signal generator 642.

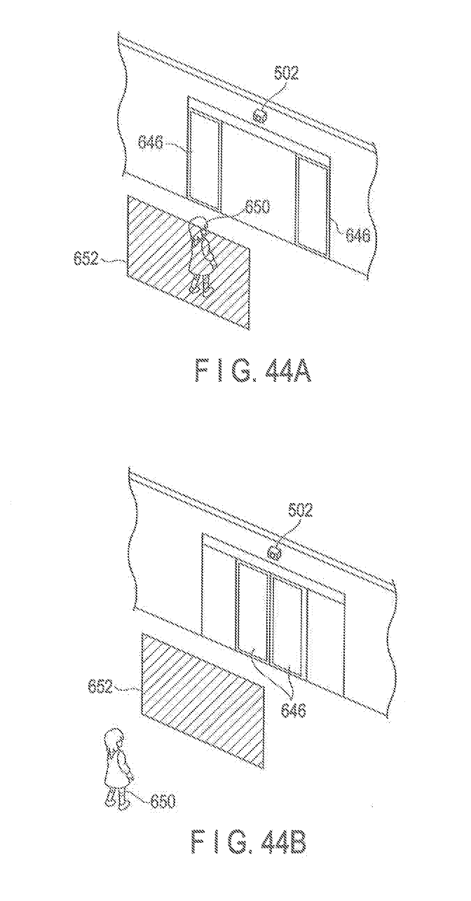

FIGS. 44A and 44B show an example of an operation of the automatic door system. The imaging apparatus 502 is installed by means of the attachment instrument shown in FIG. 28 at a position, for example, an upper portion of the door 646, at which the imaging apparatus 502 captures a person and the like moving in front of the door 646. The imaging apparatus 502 is installed to capture an image which enables a passage in front of the door 646, and the like to be viewed.

The reference distance of the control signal generator 642 is set to a certain distance from the door 646. Since the optical axis of the imaging apparatus 502 is not perpendicular to the floor, the reference plane is set to a plane 652 which is perpendicular to the floor but is not perpendicular to the optical axis of the imaging apparatus 502. The imaging apparatus 502 determines whether the person 650 is in front of or behind the reference plane 652.

In a case of FIG. 44A, it is determined that the person 650 is in front of the reference plane 652. The control signal generator 642 generates a control signal for opening the door 646 based on the result of determination. The driving device 644 makes the door 646 open in response to the control signal from the control signal generator 642.

In a case of FIG. 44B, it is determined that the person 650 is behind the reference plane 652. The control signal generator 642 generates a control signal for closing the door 646 based on the result of determination. The driving device 644 makes the door 646 closed in response to the control signal from the control signal generator 642.

The automatic door system can be applied to a door of a car. As shown in FIG. 45, a right camera 502A according to the embodiments is attached to an upper part of a windshield in front of a driver's seat of a car 660, to capture an image of the right side of the car 600 and a left camera 502B according to the embodiments is attached to an upper part of the windshield in front of the driver's seat of the car 660, to capture an image of the left side of the car 600.

A door of the car may be opened when it is determined that a position of a person changes from the far side to the near side of the first plane having the first distance from the imaging apparatus 502A or 502B. The door of the car may not be opened even if a person in the car 600 tries to open the door when it is determined that a position of a person changes from the far side to the near side of the second plane having the second distance from the imaging apparatus 502A or 502B. The second distance is shorter than the first distance. Therefore, a collision between a door and a person is prevented from being occurred when the person is close to the car.

### Application Example 3

### Moving Object Control System

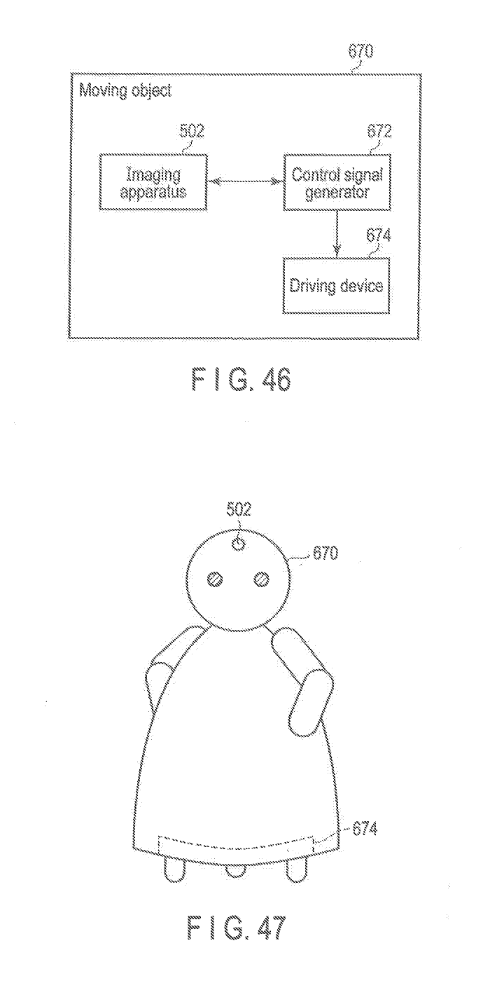

FIG. 46 illustrates an example of a functional configuration of a moving object 670 including the imaging apparatus 502. Herein, for example, a moving robot such as an automated guided vehicle (AGV), a cleaning robot for cleaning a floor, and a robot which autonomously moves such as a communication robot which provides various guide services to a visitor may be considered as the moving object 670.

The moving object 670 is not limited to such robots, and may be realized as various devices such as a vehicle including the automobile, a flying object including a drone or an airplane, and a ship as long as the device includes a driving unit for movement. The moving object 670 may also include not only the moving robot itself but also an industrial robot which includes a driving unit for movement/rotation of a part of the robot such as a robot arm.

As illustrated in FIG. 46, the moving object 670 includes the imaging apparatus 502, a control signal generator 672, and a driving device 674. As illustrated in FIG. 47, the imaging apparatus 502 is, for example, provided to capture the object in the advancing direction of the moving object 670 or a part thereof. To capture the object in the advancing direction of the moving object 670, the imaging apparatus 502 may be provided as a so-called front camera which captures the forward area, and also be provided as a so-called rear camera which captures the backward area in a reverse movement. Of course, the imaging apparatus 502 may be provided on both sides.

In addition, the imaging apparatus 502 may be provided also to function as a so-called drive recorder. In other words, the imaging apparatus 502 may be the video recording device. Further, in a case where a part of the moving object 670 controls in movement and rotation, the imaging apparatus 502 may be provided at the end of the robot arm to capture an object held in the robot arm for example.

The control signal generator 672 corresponds to the image processor 632 of FIG. 41 and generates a control signal related to at least one of an acceleration/deceleration, a stop, a collision avoidance, and a turning of the moving object 670 or a part thereof, and an actuation of a safety device such as an air bag based on the distance to the object.

The control signal generator 672 may determine whether the object enters a specific area within a specific distance or whether the object exits from the specific area, in the same manner as the control signal generator 643 of FIG. 43, based on the distance to the object.

The control signal generator 672 may generate a control signal related to at least one of a deceleration, a collision avoidance, a turning of the moving object 670 away from the object, and an actuation of the safety device when it is determined that the object is in front of the reference plane having the reference distance. The control signal generator 672 may generate a control signal related to at least one of an acceleration and a turning of the moving object 670 toward the object when it is determined that the object is behind the reference plane having the reference distance. The control signal from the control signal generator 672 is supplied to the driving device 674.

The driving device 674 drives the moving object 670 based on the control signal. That is, the driving device 674 operates based on the control signal to cause the moving object 670 or a part thereof to perform the acceleration/deceleration, the collision avoidance, and the turning of the moving object 670 or a part thereof, and an actuation of the safety device such as the air bag based on the control signal. This driving device may be applied to the movement of a robot and the automatic operation of the automobile which are necessarily controlled in real time.

In a case where the moving object 670 is a drone, at the time of inspecting a crack or a wire breaking from the sky, the imaging apparatus 502 acquires an image obtained by capturing an inspection target and determines whether the object is on the near side or on the far side from the reference distance. The control signal generator 672 generates the control signal to control thrust of the drone based on the determination result such that a distance to the inspection target is constant. The driving device 674 operates the drone based on the control signal, so that the drone can fly in parallel with the inspection target.

In addition, at the time when the drone flies, the imaging apparatus 502 acquires an image obtained by capturing the ground, detects the height of the drone from the ground, and determines whether the height is lower or higher than the reference height. The control signal generator 672 generates based on the determination result the control signal to control the thrust of the drone such that the height from the ground becomes a designated height. The driving device 674 can make the drone to fly at the designated height by operating the drone based on the control signal.

Further, in a case where the moving object 670 is the drone or the automobile, at the time of a coordinated flying of the drones or a coordinated running of the automobiles in a line, the imaging apparatus 502 acquires an image obtained by capturing a peripheral drone or a preceding automobile and determines whether the peripheral drone or the preceding automobile is on the near side or on the far side from the reference distance.

The control signal generator 672 generates based on the determination result the control signal to control a thrust of the drone or a speed of the automobile such that a distance to the peripheral drone or the preceding automobile becomes constant. The driving device 674 operates the drone or the automobile based on the control signal so that the coordinated flying of the drones or the coordinated running of the automobiles can be easily performed.

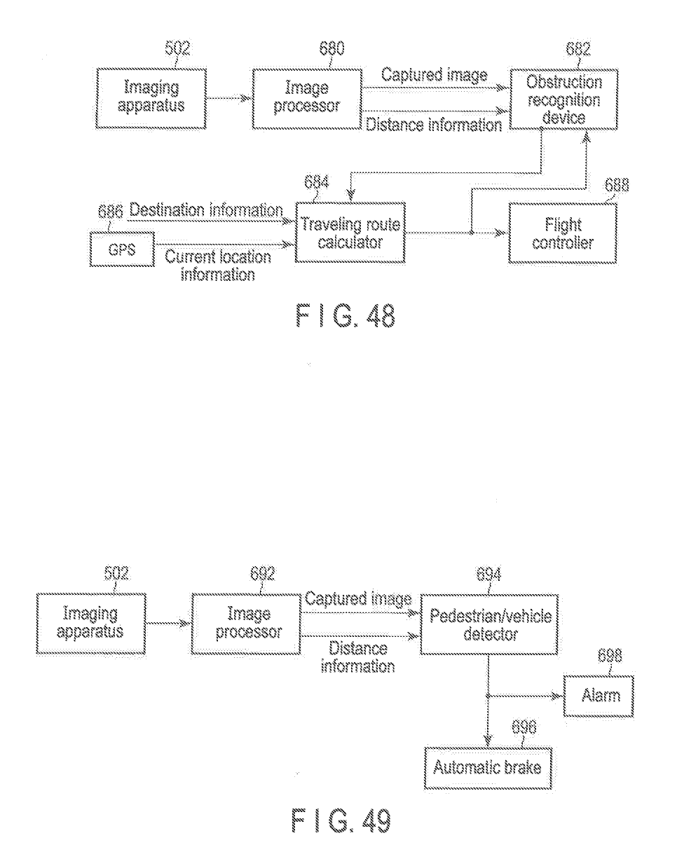

FIG. 48 shows an example of traveling control of the drone which can avoid an obstruction. An output of the imaging apparatus 502 is supplied to an image processor 680 having functions of the captured image input device 562 and the depth map input device 564 of FIG. 31. The captured image and the distance information for each pixel which are output from the imaging apparatus 502 are supplied to an obstruction recognition device 682.

The traveling route of a drone is automatically determined if a destination and a current location are recognized. The drone includes a GPS (Global Positioning System) 686, and the destination information and the current location information are input to a traveling route calculator 684. The traveling route information output from the traveling route calculator 684 is input to the obstruction recognition device 682 and a flight controller 688. The flight controller 688 executes adjustment of steering, acceleration, deceleration, thrust, lift, and the like.

The obstruction recognition device 682 extracts an object or objects within a certain distance from the drone, based on the captured image and the distance information. A detection result is supplied to the traveling route calculator 684. If the obstruction is detected, the traveling route calculator 684 corrects the traveling route determined based on the destination and the current location to a traveling route of a smooth orbit which can avoid the obstruction.

Thus, even if an unexpected obstruction appears in air, the system enables the drone to safely fly to the destination while automatically avoiding the obstruction. The system of FIG. 48 can also be applied to not only the drone, but a mobile robot (Automated Guided Vehicle), a cleaner robot, and the like having its traveling route determined. As regards the cleaner robot, the route itself is not determined but, rules of turning, moving backwards and the like if an obstruction is detected are often determined. Even in this case, too, the system of FIG. 48 can be applied to the detection and avoidance of the obstruction.

FIG. 49 is a block diagram showing an example of a vehicle driving control system. The output of the imaging apparatus 520 is input to an image processor 692 having functions of the captured image input device 562 and the depth map input device 564 of FIG. 31. The imaging apparatus 520 outputs a captured image and distance information for each pixel.

The captured image and the distance information are supplied to a pedestrian/vehicle detector 694. The pedestrian/vehicles detector 694 sets an object perpendicular to a road as a candidate area or candidate areas of a pedestrian/vehicle in the captured image, based on the captured image and the distance information. The pedestrian/vehicle detector 206 can detect a pedestrian/vehicle by calculating the feature quantity for each candidate area, and comparing this feature quantity with a number of reference data items preliminarily obtained from a large number of sample image data items. If the pedestrian/vehicle is detected, the alarm 698 may be issued to the driver or an automatic brake 696 may be activated to decelerate or stop the automobile.

The imaging apparatus 502 is not limited to the front camera in the driver's seat, but may be a side camera attached to a sideview mirror or a rear camera attached to a rear windshield. In a case of the side camera or the rear camera, it is possible to detect an obstruction during a reverse movement in the parking lot instead of the pedestrian/vehicle.

In recent years, a drive recorder which records a front view of the car captured with a camera attached to the windshield of the oar on an SD (Secure Digital) card, or the like has been developed. Not only the images captured in front of the car, but the distance information can be acquired by applying the camera of the embodiments to the camera of the drive recorder, without providing a camera inside the car separately.

The system can also be applied to, for example, a manufacturing robot which is not a movable body but stationary and which includes a movable member, and the like. If an obstruction is detected in accordance with the distance from the arm holding and moving a component and processing a component, movement of the arm may be limited.

According to embodiments, the following is provided.

(1) A processing apparatus comprising:

a memory; and

a processor electrically coupled to the memory and configured to:

acquire a first image of an object and a second image of the object, the first image including blur having a shape indicated by a symmetric first blur function, the second image including blur having a shape indicated by an asymmetric second blur function;

calculate a distance to the object, based on correlation between the first blur function and the second blur function; and

calculate reliability of the distance, based on a degree of the correlation.

(2) The processing apparatus of (1), wherein the processor is configured to:

calculate the distance from correlation between each of a plurality of corrected images and the first image, each of the plurality of the corrected images being generated by the second image and each of a plurality of convolution kernels; and

calculate the reliability of the distance, based on a curvature of a correlation function between each of the corrected images and the first image.

(3) The processing apparatus of (2), wherein the processor is configured to calculate the reliability of the distance, based on the curvature of the correlation function between each of the corrected images and the first image, and on an edge direction of an object image or edge strength of the object image.

(4) The processing apparatus of (1), wherein:

the processor is configured to output a map; and

the map indicates the distance of a plurality of first points in one of the first image and the second image and the reliability of the distance of the plurality of the first points, at a plurality of second points corresponding to the plurality of the first points.

(5) The processing apparatus of (1), wherein:

the processor is configured to output a list; and

the list indicates coordinates of the first image or the second image, the distance at the coordinates, and the reliability of the distance at the coordinates.

(6) The processing apparatus of (1), wherein:

the processor is configured to output output data; and

the output data includes acquired color image data, distance data including the distance of a plurality of points on an image indicated by the color image data, and reliability data including the reliability of the distance of the plurality of the points.

(7) An imaging apparatus comprising:

the processing apparatus of (1); and

an imaging device configured to capture the first image and the second image.

(8) The imaging apparatus of (7), wherein the first image and the second image are images captured at a same time by the imaging device.

(9) The imaging apparatus of (7), further comprising a display device capable of displaying a display image including the distance and the reliability of the distance, which are corresponding to a position on the first image or the second image.

(10) The imaging apparatus of (9), further comprising an input device configured to accept designation of a position on the display image,

wherein the display device is configured to display the distance and the reliability of the distance at a position on the first image or the second image corresponding to the position on the display image designated by the input device.

(11) The imaging apparatus of (9), wherein the display device is configured to output a message to promote rotation of the imaging apparatus, when the reliability of the distance is less than a threshold value.

(12) An automatic control system of a mobile object, comprising:

the imaging apparatus of (7); and

a controller configured to control a drive mechanism of the mobile object, based on the distance and reliability of the distance.

(13) The automatic control system of (12), wherein the controller is configured to control the drive mechanism using a lower limit of the distance calculated from the distance and reliability of the distance.

(14) The automatic control system of (13), wherein the controller is configured to stop, decelerate, accelerate or start movement of a mobile object by controlling the drive mechanism based on the lower limit.

(15) The automatic control system of (12), wherein:

the imaging apparatus is attached to a rotation mechanism, and

the controller is configured to control the rotation mechanism to make the reliability of the distance obtained from the imaging apparatus higher.

(16) An imaging apparatus comprising:

a camera comprising a filter at an aperture, the filter comprising at least a first area and a second area; and

an installing unit configured to install the camera such that a first straight line obtained by projecting a straight line indicative of a vertical direction on the filter is not parallel to a second straight line indicative of a direction of division of the first area and the second area of the filter.

(17) The imaging apparatus of (16), further comprising:

a processor configured to rotate an image captured by the camera based on an angle formed by the first straight line and the second straight line.

(18) An imaging system comprising:

the imaging apparatus of (17); and

a display configured to display a rotated captured image.

(19) A method of acquiring distance information, comprising:

capturing an image of an object by a camera which comprises a filter at an aperture, the filter comprising at least a first area and a second area, wherein a first straight line obtained by projecting a straight line indicative of a vertical direction on the filter and a second straight line indicative of a direction of division of the first area and the second area of the filter are not parallel; and

acquiring distance information indicative of a distance from the filter to the object, from a captured image of the object.

(20) The method of (19), further comprising:

rotating the captured image based on an angle formed by the first straight line and the second straight line.

(21) The method of (20), further comprising:

displaying the rotated captured image.

(22) An imaging apparatus comprising:

a camera comprising a filter at an aperture, the filter comprising at least a first area and a second area; and

an installing unit configured to install the camera such that a first straight line obtained by projecting a straight line indicative of a first main axis included in a captured image output from the camera on the filter, a second straight line obtained by projecting a straight line indicative of a second main axis perpendicular to the first main axis included in the captured image on the filter, and a third straight line indicative of a direction of division of the first area and the second area of the filter are not parallel to each other.

(23) The imaging apparatus of (22), further comprising:

a processor configured to rotate a captured image based on an angle formed by the first straight line and the second straight line.

(24) The imaging apparatus of (23), further comprising:

a display configured to display a rotated captured image.

(25) The imaging apparatus of (22), wherein

the first main axis and the second main axis extend along two orthogonal sides of a floor or a wall of a room included in an image captured by the camera.

(26) The imaging apparatus of (25), further comprising:

a processor configured to rotate a captured image based on an angle formed by the first straight line and the second straight line.

(27) The imaging apparatus of (26), further comprising:

a display configured to display a rotated captured image.

(28) The imaging apparatus of (22), wherein the first main axis or the second main axis extends along a road extension direction or a vehicle traveling direction included in an image captured by the camera.

(29) The imaging apparatus of (28), further comprising:

a processor configured to rotate a captured image based on an angle formed by the first straight line and the second straight line.

(30) The imaging apparatus of (29), further comprising:

a display configured to display a rotated captured image.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing apparatus comprising:
a memory; and
a processor electrically coupled to the memory and configured to:
acquire a first image of an object and a second image of the object, the first image including blur having a shape indicated by a symmetric first blur function, the second image including blur having a shape indicated by an asymmetric second blur function;
calculate a distance to the object, based on correlation between the first blur function and the second blur function; and
calculate reliability of the distance, based on a degree of the correlation.

2. The processing apparatus of claim 1, wherein the processor is configured to:
calculate the distance from correlation between each of a plurality of corrected images and the first image, each of the plurality of the corrected images being generated by the second image and each of a plurality of convolution kernels; and
calculate the reliability of the distance, based on a curvature of a correlation function between each of the corrected images and the first image.

3. The processing apparatus of claim 2, wherein the processor is configured to calculate the reliability of the distance, based on the curvature of the correlation function between each of the corrected images and the first image, and on an edge direction of an object image or edge strength of the object image.

4. The processing apparatus of claim 1, wherein:
the processor is configured to output a map; and
the map indicates the distance of a plurality of first points in one of the first image and the second image and the reliability of the distance of the plurality of the first points, at a plurality of second points corresponding to the plurality of the first points.

5. The processing apparatus of claim 1, wherein:
the processor is configured to output a list; and
the list indicates coordinates of the first image or the second image, the distance at the coordinates, and the reliability of the distance at the coordinates.

6. The processing apparatus of claim 1, wherein:
the processor is configured to output output data; and
the output data includes acquired color image data, distance data including the distance of a plurality of points on an image indicated by the color image data, and reliability data including the reliability of the distance of the plurality of the points.

7. An imaging apparatus comprising:
the processing apparatus of claim 1; and
an imaging device configured to capture the first image and the second image.

8. The imaging apparatus of claim 7, wherein the first image and the second image are images captured at a same time by the imaging device.

9. The imaging apparatus of claim 7, further comprising a display device capable of displaying a display image including the distance and the reliability of the distance, which are corresponding to a position on the first image or the second image.

10. The imaging apparatus of claim 9, further comprising an input device configured to accept designation of a position on the display image,
wherein the display device is configured to display the distance and the reliability of the distance at a position on the first image or the second image corresponding to the position on the display image designated by the input device.

11. The imaging apparatus of claim 9, wherein the display device is configured to output a message to promote rotation of the imaging apparatus, when the reliability of the distance is less than a threshold value.

12. An automatic control system of a mobile object, comprising:
the imaging apparatus of claim 7; and
a controller configured to control a drive mechanism of the mobile object, based on the distance and reliability of the distance.

13. The automatic control system of claim 12, wherein the controller is configured to control the drive mechanism using a lower limit of the distance calculated from the distance and reliability of the distance.

14. The automatic control system of claim 13, wherein the controller is configured to stop, decelerate, accelerate or start movement of a mobile object by controlling the drive mechanism based on the lower limit.

15. The automatic control system of claim 12, wherein:
the imaging apparatus is attached to a rotation mechanism, and
the controller is configured to control the rotation mechanism to make the reliability of the distance obtained from the imaging apparatus higher.
